(19) United States
(12) Patent Application Publication
(10) Pub. No.: US 2025/0060119 A1
(43) Pub. Date: Feb. 20, 2025

(54) AIR CONDITIONER

(71) Applicant: DAIKIN INDUSTRIES, LTD., Osaka (JP)

(72) Inventors: Kousuke TSUBOI, Osaka (JP); Takao SONODA, Osaka (JP); Makoto IKEDA, Osaka (JP); Tetsushi TSUDA, Osaka (JP); Yu OTA, Osaka (JP); Yuuichi KITA, Osaka (JP); Kenji AMANO, Osaka (JP); Atsushi MATSUBARA, Osaka (JP); Tomomi KUKITA, Osaka (JP); Naoko KURIYAMA, Osaka (JP); Tomoyoshi ASHIKAGA, Osaka (JP); Gen KUMAMOTO, Osaka (JP)

(21) Appl. No.: 18/937,991

(22) Filed: Nov. 5, 2024

Related U.S. Application Data
(62) Division of application No. 16/618,826, filed on Dec. 3, 2019.

(30) Foreign Application Priority Data
Jul. 14, 2017 (JP) 2017-138611
Jul. 14, 2017 (JP) 2017-138618
Jul. 14, 2017 (JP) 2017-138619
Jul. 14, 2017 (JP) 2017-138621
Jul. 14, 2017 (JP) 2017-138629
Jul. 14, 2017 (JP) 2017-138630
Jul. 14, 2017 (JP) 2017-138631
Mar. 30, 2018 (JP) 2018-070240

(51) Int. Cl. F24F 11/58; F24F 11/63; F24F 13/20; F24F 130/40; G05B 19/02

(52) U.S. Cl. CPC F24F 11/58; F24F 11/63; F24F 13/20; G05B 19/02; F24F 2130/40

(57) ABSTRACT

The air conditioner includes an indoor unit including a main body having formed therein a blow-out port and a microphone element that accepts a voice instruction. The blow-out port is formed to extend with a longitudinal direction thereof corresponding to a second direction. The indoor unit includes a fan and an inverter fan motor that drives the fan. The fan is accommodated in the main body and a rotational axis of the fan extends in the second direction, and the fan motor is disposed on one side of an inside of the main body in the second direction and is disposed on one side of the fan in the second direction. The voice capturing portion is disposed on an opposite side of the main body as the side on which the fan motor is disposed in the second direction.

### CROSS-REFERENCE TO RELATED APPLICATIONS

This application is a divisional application of U.S. patent application Ser. No. 16/618,826, filed on Dec. 3, 2019, which is a U.S. National stage application of International Application PCT/JP2018/026616, having an international filing date of Jul. 13, 2018, which claims priority under 35 U.S.C. § 119(a) to Japanese Patent Application Nos. 2017-138611, 2017-138618, 2017-138619, 2017-138621, 2017-138629, 2017-138630, and 2017-138631, filed in Japan on Jul. 14, 2017, and 2018-070240 filed in Japan on Mar. 30, 2018, the entire contents of which are hereby incorporated herein by reference.

### TECHNICAL FIELD

The present disclosure relates to an air conditioner.

### BACKGROUND ART

As disclosed in Japanese Laid-open Patent Publication No. H2-171098, an apparatus is known that enables operation of devices by voice. Japanese Laid-open Patent Publication No. H2-171098 relates to a remote control apparatus that remotely controls devices by voice.

### SUMMARY

In contrast to such a remote control apparatus for remote control, if a microphone element that accepts voice instructions is provided to a device itself, the device to be used can be operated at a location near the device even if no remote control apparatus is located nearby, which provides high convenience. In addition, if a microphone element is provided to the device itself, issues involved with a portable remote control apparatus, such as losing an operation apparatus, do not arise.

However, when the device is an air conditioner and an indoor unit of the air conditioner is provided with a microphone element, depending on the arrangement of the microphone element, issues may occur, such as the effect of blowing noise of the air blown out from a blow-out port in the indoor unit resulting in failure to acquire voice instructions or failure to correctly recognize instructions due to deterioration in the quality of acquired voice.

An object is to provide an air conditioner including an indoor unit provided with a microphone element that accepts voice instructions, such that a voice instruction spoken by an operator is acquired with high quality and control based on the voice instruction spoken by the operator is likely to be ensured.

An air conditioner according to a first aspect includes an indoor unit, a transmission unit, and a reception unit. The indoor unit has a main body and a microphone element. The main body has formed therein a blow-out port through which air-conditioned air is blown out toward a space to be air-conditioned. The microphone element accepts a voice instruction captured from a voice capturing portion. The voice capturing portion is arranged at a position that deviates from a ventilation space through which the air blown out from the blow-out port flows, in such a manner as to face the space to be air-conditioned. The transmission unit transmits a signal that is based on the voice instruction accepted by the microphone element to an outside. The reception unit receives from the outside a command corresponding to the signal transmitted from the transmission unit.

In the indoor unit of the air conditioner, a portion for capturing voice instructions is arranged at a position that deviates from the ventilation space through which the air blown out from the blow-out port flows. This makes input of voice instructions to the microphone element less susceptible to blowing noise, and the microphone element can acquire less noisy voice instructions. Even if a voice spoken by an operator is weak, the microphone element is likely to acquire a clear voice instruction. A command based on the voice instruction is generated outside the air conditioner on the basis of the acquired clear voice instruction, and is transmitted to the air conditioner. Thus, for example, even if diversity instructions are given to the air conditioner by voice, malfunction of the air conditioner (in addition to a case where an operation different from that indicated in a voice instruction given from the operator is performed, a case where a voice instruction given from the operator is not recognized) is less likely to occur.

Here, a functional unit that converts a signal based on voice into a command is disposed outside the air conditioner, and the air conditioner does not need to individually have this function. Thus, a reduction in the cost of the air conditioner can be achieved.

An air conditioner according to a second aspect is the air conditioner according to the first aspect, wherein the blow-out port is formed in a lower surface of the main body, through which air is blown out in a first direction in bottom view. The voice capturing portion is disposed in the lower surface of the main body at a location other than the downstream side of the blow-out port in the first direction in bottom view.

Here, the voice capturing portion can be disposed out of the ventilation space, and the microphone element is likely to acquire a clear voice instruction.

An air conditioner according to a third aspect is the air conditioner according to the first aspect or the second aspect, wherein the blow-out port is formed in a first surface of the main body. The voice capturing portion is disposed in a second surface of the main body that intersects the first surface.

Here, since the voice capturing portion is disposed in a surface intersecting the surface on which the blow-out port is formed, the voice capturing portion can be disposed out of the ventilation space, and the microphone element is likely to acquire a clear voice instruction.

An air conditioner according to a fourth aspect is the air conditioner according to any one of the first aspect through the third aspect, wherein the blow-out port is formed in the main body so as to extend with its longitudinal direction corresponding to a second direction. The voice capturing portion is disposed on the extension of the blow-out port in the second direction.

Here, the voice capturing portion can be disposed out of the ventilation space, and the microphone element is likely to acquire a clear voice instruction.

An air conditioner according to a fifth aspect is the air conditioner according to any one of the first aspect through the fourth aspect, wherein the main body further has formed therein a suction port through which air is sucked from the space to be air-conditioned. The voice capturing portion is disposed on the main body between the blow-out port and the suction port.

Here, the voice capturing portion can be disposed out of the ventilation space, and the microphone element is likely to acquire a clear voice instruction.

An air conditioner according to a sixth aspect is the air conditioner according to any one of the first aspect through the fifth aspect, wherein the voice capturing portion is disposed on the main body in a surface that intersects both the vertical plane and the horizontal plane and that is visible in bottom view.

Here, the voice capturing portion is disposed in a surface that is visible in bottom view (i.e., directed downwards) and that intersects both the vertical plane and the horizontal plane (in other words, an inclined surface). Thus, it is easy for the microphone element to more clearly acquire a voice instruction given from an operator in the space to be air-conditioned.

An air conditioner according to a seventh aspect is the air conditioner according to the first aspect, wherein the indoor unit is of a wall-mounted type. The blow-out port is formed so as to extend with its longitudinal direction corresponding to a second direction. The indoor unit further has a fan, and a fan motor that drives the fan. The fan is accommodated in the main body. The fan motor is arranged on one side of the inside of the main body in the second direction. The voice capturing portion is disposed on a side of the main body opposite to the side on which the fan motor is disposed in the second direction.

Here, the voice capturing portion of the microphone element is disposed away from the fan motor. This makes the microphone element less susceptible to noise of the fan motor, and the microphone element is likely to acquire a clear voice instruction.

An air conditioner according to an eighth aspect is the air conditioner according to the first aspect, wherein the indoor unit is of a wall-mounted type. The blow-out port is formed so as to extend with its longitudinal direction corresponding to a second direction. The indoor unit further has a fan, and a fan motor that drives the fan. The fan is accommodated in the main body. The fan motor is arranged on one side of the inside of the main body in the second direction. The voice capturing portion is disposed on the same side of the main body as the side on which the fan motor is disposed in the second direction.

Here, electric components including the microphone element and the fan motor can be gathered and arranged on one side of the main body, and the man-hours in performing a wiring task during production of the indoor unit can thus be reduced.

An air conditioner according to a ninth aspect is the air conditioner according to the first aspect, wherein the indoor unit is of a floor-mountable type. The voice capturing portion is disposed above the center of the main body in a height direction.

In a floor-mounted indoor unit, a fan motor, which is heavy, is generally arranged in a lower portion of the indoor unit. Accordingly, here, the voice capturing portion is disposed in an upper portion of the indoor unit (above the center of the main body). Thus, the microphone element is less susceptible to noise of the fan motor and is likely to acquire a clear voice instruction.

In addition, when the voice capturing portion is disposed in a lower portion of the indoor unit, a voice instruction given by a standing or seated operator can be impeded by obstacles (for example, furniture such as a table or chair). In contrast, here, the voice capturing portion is disposed in an upper portion of the indoor unit, and thus a voice instruction is likely to be captured through the voice capturing portion without obstruction.

An air conditioner according to a tenth aspect is the air conditioner according to the first aspect, wherein the indoor unit is of a wall-mounted type. The blow-out port is formed so as to extend with its longitudinal direction corresponding to a second direction. The voice capturing portion is disposed above the blow-out port and in the center portion of the main body in the second direction.

Here, the voice capturing portion is disposed in the center portion of the main body. Thus, even if the voice capturing portion is disposed in only one location, voice can be acquired from various directions.

An air conditioner according to an eleventh aspect is the air conditioner according to the first aspect, wherein the indoor unit is of a wall-mounted type. The indoor unit has two or more combinations each including a voice capturing portion and a microphone element that accepts a voice instruction captured from the voice capturing portion. The blow-out port is formed so as to extend with its longitudinal direction corresponding to a second direction. The voice capturing portions are disposed at least at both ends of the main body in the second direction.

Here, the voice capturing portions are disposed at least at both ends of the main body, and voice is thus easily acquired from various directions.

An air conditioner according to a twelfth aspect is the air conditioner according to the first aspect through the eleventh aspect, wherein the indoor unit further has a voice recognition chip. The voice recognition chip recognizes only a specific voice instruction among voice instructions acquired by the microphone element and generates a predetermined command. The transmission unit transmits a signal that is based on a voice instruction other than the specific voice instruction among the voice instructions accepted by the microphone element to the outside.

Here, the specific voice instruction can be converted into a command on the air conditioner side without being transmitted to the outside. This enables quick operation in response to the specific instruction, and provides high convenience.

An air conditioner according to a thirteenth aspect is the air conditioner according to the twelfth aspect, wherein the indoor unit further has a control board that controls an operation of the indoor unit. The control board and the voice recognition chip are integrated with each other.

Here, it is possible to reduce the man-hours in performing a wiring task during production of the indoor unit.

An air conditioner according to a fourteenth aspect is the air conditioner according to any one of the first aspect through the thirteenth aspect, wherein the transmission unit transmits a signal to an analysis apparatus that analyzes the signal via a network. The reception unit receives a command generated based on a result of analysis of the signal by the analysis apparatus.

Here, the signal that is based on the voice instruction is transmitted to the external analysis apparatus, and the command is generated on the basis of the result of analysis of the signal. Thus, even if the air conditioner is caused to execute a relatively complex operation, the air conditioner can be operated by voice.

An air conditioner according to a fifteenth aspect is the air conditioner according to the fourteenth aspect, wherein the transmission unit further transmits information on a state quantity for at least one of the air conditioner and the space to be air-conditioned to the command generation apparatus. The reception unit receives a command generated by the command generation apparatus based on the result of analysis of the signal by the analysis apparatus and the information on the state quantity.

Here, the instruction is given to the air conditioner on the basis of the result of analysis of the signal that is based on the voice instruction and on the basis of the state quantity for the air conditioner or the space to be air-conditioned, and thus it is likely that appropriate control of the air conditioner is executed.

An air conditioner according to a sixteenth aspect is the air conditioner according to any one of the first aspect through the fifteenth aspect, wherein the indoor unit further has a voice-capture-direction adjustment mechanism capable of changing a direction in which voice is captured by the voice capturing portion.

Here, since the direction in which voice is captured is changeable, it is possible to avoid a failure of the direction of voice capturing being directed to a place where no person is generally present (for example, to the wall), regardless of the attachment position or the like of the indoor unit. In addition, since the direction in which voice is captured can be changed, the microphone element is likely to acquire a clear voice instruction even if a voice spoken by an operator is weak.

An air conditioner according to a seventeenth aspect is the air conditioner according to the sixteenth aspect, wherein the indoor unit further has a detection unit that detects a position of a person in the space to be air-conditioned. The voice-capture-direction adjustment mechanism has an automatic adjustment unit that automatically changes the direction in which voice is captured by the voice capturing portion in accordance with a detection result of the detection unit.

Here, the direction of voice capturing is automatically changed in accordance with the position of a person in the space to be air-conditioned. Thus, it is easy for the microphone element to acquire a clear voice instruction anywhere an operator moves within the space to be air-conditioned.

### BRIEF DESCRIPTION OF THE DRAWINGS

FIG. 1 is a schematic configuration diagram of a device control system including an air conditioner according to a first embodiment.

FIG. 2 is a schematic block diagram of the device control system of FIG. 1. In FIG. 2, some of the components of the device control system are not depicted. FIG. 2 is also used to describe a device control system including an air conditioner according to second through sixth embodiments.

FIG. 3 is a schematic perspective view of a main body of an indoor unit of the air conditioner of FIG. 1.

FIGS. 4A-4C include schematic illustrations of the blow-out of air from a blow-out port in the main body of the indoor unit of FIG. 3. FIG. 4A is a view of the main body, as viewed from one side, FIG. 4B is a view of the main body, as viewed from below, and FIG. 4C is a view of the main body, as viewed from the front (in the front direction).

FIGS. 5A-5B include schematic illustrations exemplifying how a microphone element is attached to the main body of the indoor unit of FIG. 1. In the aspect of FIG. 5A, the microphone element is accommodated in the main body, which uses an opening formed in the main body as a voice capturing portion, and voice captured by the voice capturing portion is received by the microphone element arranged inside the main body. In the aspect of FIG. 5B, the microphone element is attached to the main body so as to be exposed from a surface of the main body, a portion of the microphone element facing a space to be air-conditioned is used as a voice capturing portion, and voice captured by the voice capturing portion is received by the microphone element.

FIG. 6 is a schematic bottom view of a main body of an indoor unit of an air conditioner according to a second embodiment.

FIG. 7 is a schematic sectional view taken along the VII-VII cross-section of FIG. 6. In FIG. 7, the illustration of internal devices and the like of the indoor unit is omitted.

FIG. 8 is a schematic illustration of the blow-out of air from blow-out ports in the main body of the indoor unit when the main body of the indoor unit of FIG. 6 is viewed from below.

FIG. 9 is a schematic sectional view taken along the IX-IX cross-section of FIG. 6. In FIG. 9, the illustration of internal devices and the like of the indoor unit is omitted.

FIG. 10 is a schematic bottom view of a main body of an indoor unit of an air conditioner according to a third embodiment.

FIG. 11 is a schematic bottom view of a main body of an indoor unit of an air conditioner according to a fourth embodiment.

FIG. 12 is a schematic side view of a main body of an indoor unit of an air conditioner according to a fifth embodiment.

FIG. 13 is a schematic bottom view of the main body of the indoor unit of the air conditioner of FIG. 12.

FIG. 14 is a schematic side view of a main body of an indoor unit of an air conditioner according to a sixth embodiment.

FIG. 15 is a schematic front view of a main body of an indoor unit of an air conditioner according to a seventh embodiment.

FIG. 16 is a schematic illustration of an indoor unit of an air conditioner according to Modification 1A, which is provide with a voice-capture-direction adjustment mechanism capable of changing the direction in which voice is captured by a voice capturing portion.

FIG. 17 is a schematic illustration of the voice-capture-direction adjustment mechanism of FIG. 16.

FIG. 18 is a schematic block diagram of the air conditioner when the voice capturing portion automatically changes the direction in which voice is captured by using the voice-capture-direction adjustment mechanism of FIG. 17.

### DESCRIPTION OF EMBODIMENTS

The following describes embodiments with reference to the drawings. The configuration of each of the following embodiments may be combined with the configuration of any other embodiment or the configuration of any modification as appropriate so long as consistency is maintained between them.

### First Embodiment

An air conditioner 10 according to a first embodiment will be described.

### (1) Overview of Device Control System

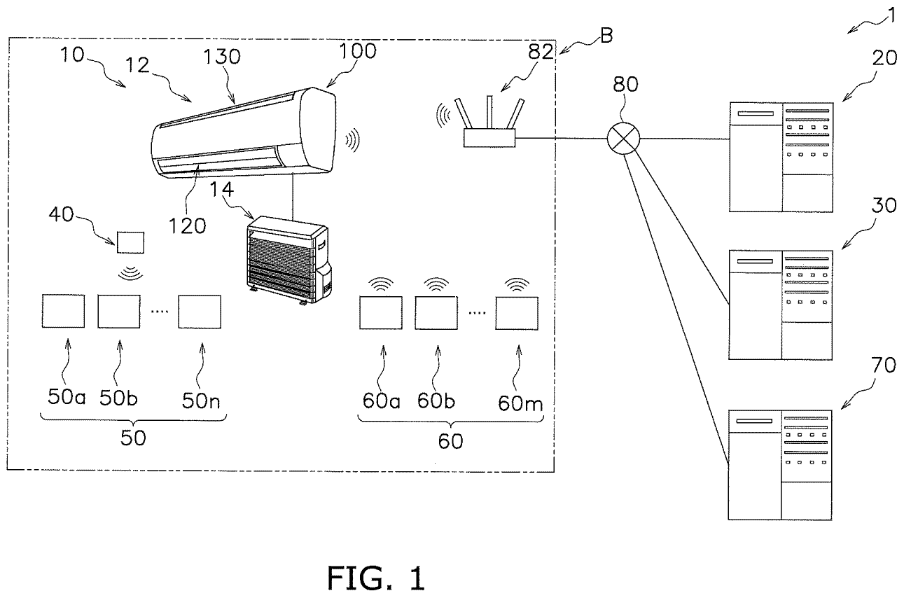

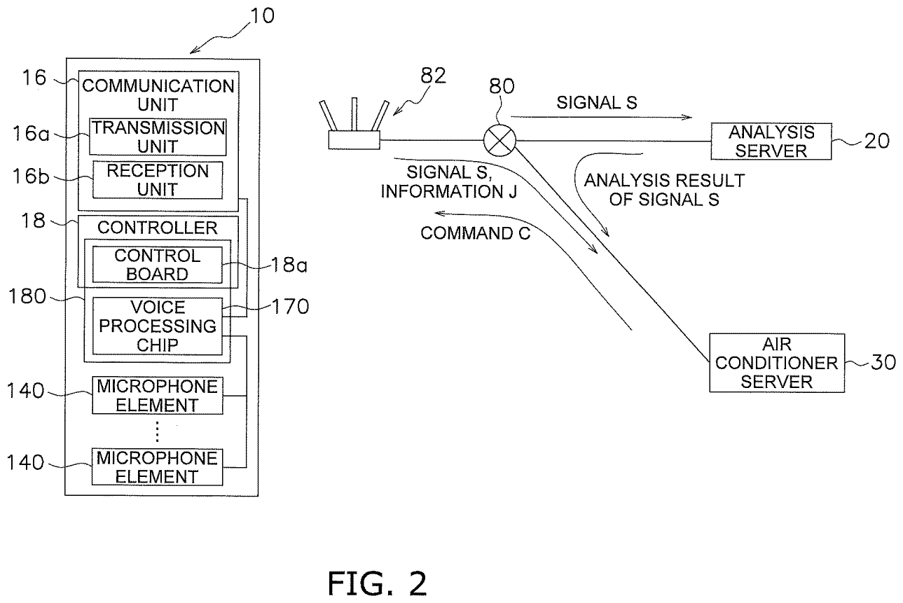

First, a device control system 1 including the air conditioner 10 will be described with reference to mainly FIG. 1 and FIG. 2.

FIG. 1 is a schematic configuration diagram of the device control system 1 including the air conditioner 10. FIG. 2 is a schematic block diagram of the device control system 1. In FIG. 2, some of the components of the device control system 1 are not depicted.

The device control system 1 is a system that controls the air conditioner 10 using instructions given by an operator by voice. Further, the device control system 1 is a system that controls devices 50a, 50b, . . . , and 50n included in a first device group 50 and devices 60a, 60b, . . . , and 60m included in a second device group 60 described below using instructions given by an operator by voice.

The device control system 1 mainly includes the air conditioner 10, the first device group 50, the second device group 60, an infrared output device 40, an analysis server 20, an air conditioner server 30, and a device server 70 (see FIG. 1).

The air conditioner 10, the first device group 50, the second device group 60, and the infrared output device 40 are devices arranged in a building B (see FIG. 1). The building B is, for example, but not limited to, a detached house. The building B may be an office building, a commercial facility, a factory, or the like. The analysis server 20, the air conditioner server 30, and the device server 70 are generally, but not limited to, installed in locations different from the building B.

FIG. 1 depicts one building B in which the air conditioner 10, the first device group 50, and the second device group 60, whose operations are controlled by the device control system 1, are arranged. However, a plurality of buildings B may be used. That is, the device control system 1 may be a system that controls the operation of the air conditioners 10, the first device groups 50, and the second device groups 60 arranged in each of the plurality of buildings B. For simplicity of description, it is assumed here that a single building B is used.

Further, the number of air conditioners 10, the number of devices in the first device group 50, the number of devices in the second device group 60, and the number of infrared output devices 40, which are arranged in the building B, are not limited to those depicted in FIG. 1, and may be each one or more. The following description is made assuming that one air conditioner 10 and one infrared output device 40 are arranged in the building B and the first device group 50 and the second device group 60 arranged in the building B each include a plurality of devices.

The following further describes the air conditioner 10, the first device group 50, the second device group 60, the infrared output device 40, the analysis server 20, the air conditioner server 30, and the device server 70.

### (1-1) Air Conditioner

The air conditioner 10 mainly has an indoor unit 12, an outdoor unit 14, a connection pipe (not illustrated) that connects the indoor unit 12 and the outdoor unit 14 to each other, a communication unit 16, a controller 18, and microphone elements 140 (see FIG. 1 and FIG. 2). The air conditioner 10 is an apparatus that performs air-conditioning of a space to be air-conditioned. The space to be air-conditioned is, for example, a room where the indoor unit 12 is arranged in the building B.

The air conditioner 10 is an air conditioner that can be operated by inputting a voice instruction to the microphone elements 140 (see FIG. 2). Non-limiting examples of the voice instruction include voice such as “turn air conditioning on” and “set the set temperature to 25° C.”. The air conditioner 10 may be configured to be operable using a typical remote control in addition to operation via voice.

In the device control system 1, the microphone elements 140 are configured to be capable of also accepting voice instructions for the devices 50a, 50b, . . . , and 50n in the first device group 50 and the devices 60a, 60b, . . . , and 60m in the second device group 60.

The voice-based operations of the air conditioner 10, the devices 50a, 50b, . . . , and 50n in the first device group 50, and the devices 60a, 60b, . . . , and 60m in the second device group 60 will be described below.

In the air conditioner 10, the indoor unit 12 and the outdoor unit 14 are connected to each other via the connection pipe, thereby connecting an indoor heat exchanger (not illustrated) of the indoor unit 12 and a compressor, an outdoor heat exchanger, an expansion valve, and the like (not illustrated) of the outdoor unit 14 to each other via a pipe. Consequently, a refrigerant circuit is formed. In the air conditioner 10, refrigerant is circulated in the refrigerant circuit, thereby cooling/heating the space where the indoor unit 12 is installed.

In this embodiment, the air conditioner 10 is configured such that in the indoor heat exchanger of the indoor unit 12, refrigerant flowing in the indoor heat exchanger and air in the space to be air-conditioned exchange heat; however, the air conditioner is not limited to such a device. For example, the air conditioner 10 may be an apparatus configured such that in the indoor heat exchanger of the indoor unit 12 (fan coil unit), cold water/hot water flowing in the indoor heat exchanger and air in the space to be air-conditioned exchange heat.

The operation of the air conditioner 10 is controlled by the controller 18. The controller 18 includes, for example, a control board 18a included in the indoor unit 12 and a control board (not illustrated) included in the outdoor unit 14. The operation of the components of the indoor unit 12 is mainly controlled by the control board 18a of the indoor unit 12, and the operation of the components of the outdoor unit 14 is mainly controlled by the control board of the outdoor unit 14. CPUs on the control boards of the indoor unit 12 and the outdoor unit 14, which constitute the controller 18, execute an air conditioning control program to control the operation of the components of the air conditioner 10 in accordance with a command C or the like described below transmitted from the air conditioner server 30.

The operational principle and the content of the operation of the air conditioner 10 using a vapor compression refrigeration cycle are widely known to the public and will not be described here. The air conditioner 10 does not need to be an air conditioner capable of both cooling/heating the space to be air-conditioned, and may be a cooling-only or heating-only air conditioner.

The indoor unit 12 has a voice processing chip 170 as another electronic component of the control board 18a. The voice processing chip 170 is an example of a voice recognition chip. Further, the voice processing chip 170 is an example of a voice recognition unit. The voice processing chip 170 is an integrated circuit that processes voice instructions acquired by the microphone elements 140 to generate a signal S described below. Further, the voice processing chip 170 is an integrated circuit that recognizes only a specific voice instruction among the voice instructions acquired by the microphone elements 140 (executes voice recognition processing on the voice instructions to recognize only a specific voice instruction) and generates a predetermined command C0.

The specific voice instruction indicates voice for, for example, requesting the air conditioner 10 to prepare to input the next voice instruction. The predetermined command C0 includes, for example, a command for requesting the microphone elements 140 to accept the subsequent voice instruction. Further, the predetermined command C0 includes, for example, a command for requesting a transmission unit 16a of the communication unit 16 described below to prepare to transmit the signal S that is based on a voice instruction (accepted subsequently to the specific voice instruction), other than the specific voice instruction, among the voice instructions accepted by the microphone elements 140.

The specific voice instruction may not be voice for requesting the air conditioner 10 to prepare to input the next voice instruction. For example, the specific voice instruction may be voice for requesting execution of the basic operation (for example, turning on/off) of the air conditioner 10, and the predetermined command C0 generated in accordance with the specific voice instruction may be a command for requesting the controller 18 to start/stop the operation of the air conditioner 10. The signal S that is based on a voice instruction for requesting execution of an operation of the air conditioner 10, other than the basic operation, may be transmitted to the outside (the analysis server 20).

The voice processing chip 170 is preferably integrated with the control board 18a. That is, the indoor unit 12 preferably has a module 180 into which the control board 18a and the voice processing chip 170 are integrated with each other (see FIG. 2).

The air conditioner 10 has the communication unit 16 for communicating with the analysis server 20 or the air conditioner server 30 external to the air conditioner 10. The air conditioner 10 (the communication unit 16) is connected to the analysis server 20 and the air conditioner server 30 via a network 80 (see FIG. 1). The network 80 is the Internet, here, but may be any other WAN. The air conditioner 10 is connected to a router 82 via a wireless LAN, and is connected to the network 80 via the router 82 (see FIG. 1). The router 82 has a WAN-side interface and a LAN-side interface, and interconnects a WAN and a LAN. The air conditioner 10 and the router 82 may be connected via a wired LAN, rather than via a wireless LAN.

The network 80 may be a LAN.

The communication unit 16 is, for example, a wireless LAN adapter that performs wireless communication with the router 82. The communication unit 16 has, as functional units, the transmission unit 16a that transmits information, and a reception unit 16b that receives information (see FIG. 2).

The transmission unit 16a transmits, for example, the signal S that is based on a voice instruction accepted by the microphone elements 140 to the outside (see FIG. 2). In particular, the transmission unit 16a transmits the signal S that is based on a voice instruction other than the specific voice instruction among the voice instructions accepted by the microphone elements 140 to the outside. However, this is not limiting, and the transmission unit 16a may transmit, for all the voice instructions accepted by the microphone elements 140, signals S that are based on the voice instructions to the outside.

Here, the signal S is a digital voice signal obtained by subjecting the voice instruction to AD conversion by the voice processing chip 170. The signal S may be data obtained by, for example, further compressing the digital voice signal by the voice processing chip 170 using various voice data compression techniques (such as MP3). Alternatively, the signal S may be data obtained by converting the voice instruction into text (voice-to-text converted data) by the voice processing chip 170. The transmission unit 16a preferably transmits the signal S to a plurality of addresses (for example, to the analysis server 20 and the air conditioner server 30).

Further, the transmission unit 16a preferably transmits information J on the state quantity for at least one of the air conditioner 10 and the space to be air-conditioned to the air conditioner server 30 (see FIG. 2). Non-limiting examples of the state quantity for the air conditioner 10 include temperatures/pressures of refrigerant measured by sensors (not illustrated) at various locations in the refrigerant circuit, the number of revolutions of an inverter-controlled motor (not illustrated) of the compressor of the outdoor unit 14, and the opening degree of the expansion valve of the outdoor unit 14. Non-limiting examples of the state quantity for the space to be air-conditioned include the temperature of the space to be air-conditioned measured by a sensor (not illustrated).

The reception unit 16b receives, for example, the command C corresponding to the signal S transmitted from the transmission unit 16a (in particular, the signal S that is based on a voice instruction for control of the air conditioner 10) from the outside. More specifically, the reception unit 16b receives the command C generated on the basis of the result of analysis of the signal S by the analysis server 20 (in particular, the signal S that is based on a voice instruction for control of the air conditioner 10). Preferably, the reception unit 16b receives the command C generated by the air conditioner server 30 on the basis of the result of analysis of the signal S by the analysis server 20 (in particular, the signal S that is based on a voice instruction for control of the air conditioner 10) and on the basis of the information J on the state quantity transmitted from the transmission unit 16a to the air conditioner server 30.

The controller 18 that controls the operation of the air conditioner 10 controls the operation of the air conditioner 10 in accordance with the command C. For example, but not limitation, the command C is related to at least one of turning on/off of the operation of the air conditioner 10, switching among the operating modes (cooling/heating/dehumidification/ventilation, etc.) of the air conditioner 10, changing of the set temperature (the target temperature of the space to be air-conditioned), a target value of the number of revolutions of the inverter-controlled motor (not illustrated) of the compressor of the outdoor unit 14, a target value of the opening degree of the expansion valve of the outdoor unit 14, and a target value of the number of revolutions of an inverter-controlled fan motor 160 of a fan 150 of the indoor unit 12.

### (1-2) First Device Group

The devices 50a, 50b, . . . , and 50n in the first device group 50 are devices that can be operated using infrared signals. The devices 50a, 50b, . . . , and 50n in the first device group 50 include, for example, but not limitation, an electric fan, a lighting device, and an audio device. The devices 50a, 50b, . . . , and 50n in the first device group 50 may not be connected to the network 80.

The devices 50a, 50b, . . . , and 50n in the first device group 50 are devices that can be operated using infrared signals transmitted from the infrared output device 40 in response to input of voice instructions to the microphone elements 140 of the air conditioner 10. Operations available by infrared signals include, for example, turning on/off the devices 50a, 50b, . . . , and 50n, changing the level of ventilation in the case of an electric fan, changing the brightness in the case of a lighting device, and changing the volume level in the case of an audio device.

The devices 50a, 50b, . . . , and 50n in the first device group 50 may be configured to be operable with a typical infrared remote control or switches on the main bodies of the devices 50a, 50b, . . . , and 50n, in addition to operation via voice (in addition to operation using infrared signals transmitted from the infrared output device 40 in response to input of voice instructions).

### (1-3) Second Device Group

The devices 60a, 60b, . . . , and 60m in the second device group 60 are devices that can be operated using signals transmitted via the network 80. The devices 60a, 60b, . . . , and 60m in the second device group 60 include, for example, but not limitation, a television set and a DVD recorder. The devices 60a, 60b, . . . , and 60m in the second device group 60 each have a wireless LAN adapter (not illustrated) and are connected to the network 80 via the router 82 (see FIG. 1). The devices 60a, 60b, . . . , and 60m in the second device group 60 are communicably connected to at least one of the analysis server 20 and the device server 70 via the network 80 (see FIG. 1). The devices 60a, 60b, . . . , and 60m in the second device group 60 and the router 82 may be connected via a wired LAN, rather than via a wireless LAN.

The devices 60a, 60b, . . . , and 60m in the second device group 60 are operated using signals transmitted from the analysis server 20 or the device server 70 in response to input of voice instructions to the microphone elements 140 of the air conditioner 10. Operations available by signals transmitted from the analysis server 20 or the device server 70 include, for example, turning on/off the devices 60a, 60b, . . . , and 60m, changing the channel or volume level of a television set, and setting a programmed recording on a DVD recorder.

The devices 60a, 60b, . . . , and 60m in the second device group 60 may be configured to be operable with a commonly available remote control or switches on the main bodies of the devices 60a, 60b, . . . , and 60m, in addition to operation via voice (in addition to operation by signals transmitted via the network 80 in response to input of voice instructions).

### (1-4) Analysis Server

The analysis server 20 is an example of an analysis apparatus.

The analysis server 20 is connected to the air conditioner 10 (the communication unit 16) via the network 80. When the microphone elements 140 of the air conditioner 10 accept a voice instruction, as described above, the transmission unit 16a of the air conditioner 10 transmits the signal S that is based on the voice instruction to the analysis server 20 via the network 80 (see FIG. 2). Voice instructions accepted by the microphone elements 140 include a voice instruction for control of the air conditioner 10, voice instructions for control of the devices 50a, 50b, . . . , and 50n in the first device group 50, and voice instructions for control of the devices 60a, 60b, . . . , and 60m in the second device group 60. In other words, the analysis server 20 receives the signals S that are based on the voice instructions for control of the air conditioner 10, the devices 50a, 50b, . . . , and 50n, and the devices 60a, 60b, . . . , and 60m.

Further, the analysis server 20 is communicably connected to the air conditioner server 30, the device server 70, and the infrared output device 40 via the network 80.

The analysis server 20 is a computer that executes a program stored in a storage device to analyze the received signal S. Specifically, for example, the analysis server 20 performs voice recognition of a received voice signal.

The storage device of the analysis server 20 stores, in addition to the program, for example, a list of devices that can be operated by input of voice instructions to the microphone elements 140 (the air conditioner 10, the devices 50a, 50b, . . . , and 50n in the first device group 50, and the devices 60a, 60b, . . . , and 60m in the second device group 60). That is, the analysis server 20 knows which device can be operated by input of a voice instruction to the microphone elements 140. In addition, for the devices 60a, 60b, . . . , and 60m in the second device group 60, information as to whether the device 60a, 60b, . . . , or 60m to be controlled is a direct control target of the analysis server 20 (a control target of either of the analysis server 20 and the device server 70) is also stored.

The analysis server 20 analyzes the voice represented by the signal S to determine a feature value for the voice, and generates text information from the feature value by using a voice recognition dictionary stored in the storage device, which includes an acoustic model, a linguistic model, and a pronunciation dictionary. Non-limiting examples of the text information generated by the analysis server 20 include text information such as “turn the air conditioner on”, “set the set temperature of the air conditioner to 25 degrees”, “turn the lighting device off”, and “turn the television set on”.

When the text information is related to control of the air conditioner 10 (for example, when the text information includes an air-conditioner-related keyword), the analysis server 20 transmits the analysis result of the signal S (i.e., the generated text information) to the air conditioner server 30 via the network 80 (see FIG. 2).

When the text information is related to control of the device 50a, 50b, . . . , or 50n in the first device group 50 (for example, when the text information includes a keyword related to the first device group 50), the analysis server 20 transmits a command to the infrared output device 40 to provide an instruction to transmit an infrared signal corresponding to the analysis result of the signal S (i.e., the generated text information). For example, when the text information is information concerning a lighting device included in the devices 50a, 50b, . . . , and 50n in the first device group 50 (for example, “turn the lighting device off”), the analysis server 20 transmits a command to the infrared output device 40 to transmit an infrared signal for instructing the lighting device to turn off. The command directed to the infrared output device 40 is transmitted from the analysis server 20 to the infrared output device 40 via the network 80.

When the text information is related to control of the device 60a, 60b, . . . , or 60m in the second device group 60 (for example, when the text information includes a keyword related to the second device group 60), the analysis server 20 transmits a command corresponding to the analysis result of the signal S (i.e., the generated text information) to the device 60a, 60b, . . . , or 60m in the second device group 60. For example, when the text information is information concerning a television set included in the devices 60a, 60b, . . . , and 60m in the second device group 60 (for example, “turn the television set on”), the analysis server 20 transmits a command to the television set to provide an instruction to turn on the switch. Commands directed to the devices 60a, 60b, . . . , and 60m in the second device group 60 are transmitted from the analysis server 20 to the devices 60a, 60b, . . . , and 60m in the second device group 60 via the network 80.

When the text information is related to control of the device 60a, 60b, . . . , or 60m in the second device group 60 and the device 60a, 60b, . . . , or 60m to be controlled is not a direct control target of the analysis server 20, the text information is transmitted to the device server 70 that controls the corresponding device 60a, 60b, . . . , or 60m. Then, a command is transmitted from the device server 70 to the corresponding device 60a, 60b, . . . , or 60m via the network 80.

### (1-5) Air Conditioner Server

The air conditioner server 30 is an example of a command generation apparatus.

The air conditioner server 30 generates the command C on the basis of the result of analysis of the signal S by the analysis server 20 (i.e., the text information generated by the analysis server 20), which is transmitted from the analysis server 20, and on the basis of the information J on the state quantity for at least one of the air conditioner 10 and the space to be air-conditioned, which is transmitted as appropriate from the transmission unit 16a of the air conditioner 10. Then, the air conditioner server 30 transmits the command C to the reception unit 16b of the air conditioner 10 via the network 80.

Here, without limitation, the air conditioner server 30 generates the command C on the basis of the information J in addition to the result of analysis of the signal S by the analysis server 20. The air conditioner server 30 may generate the command C on the basis of only the result of analysis of the signal S by the analysis server 20.

Further, the air conditioner server 30 accumulates signals S transmitted from the transmission unit 16a of the air conditioner 10 and performs various analysis operations by using the signals S.

In this embodiment, without limitation, the device control system 1 includes the air conditioner server 30. For example, when the air conditioner 10 is capable of directly determining the content of the operation on the basis of the result of analysis of the signal S by the analysis server 20 (i.e., the text information generated by the analysis server 20), the air conditioner server 30 may not be disposed. The result of analysis of the signal S by the analysis server 20 may be transmitted directly to the reception unit 16b of the air conditioner 10 as the command C.

### (1-6) Device Server

The device server 70 generates a command for the device 60a, 60b, . . . , or 60m in the second device group 60 on the basis of the result of analysis of the signal S by the analysis server 20 (i.e., the text information generated by the analysis server 20), which is transmitted from the analysis server 20. Then, the device server 70 transmits the command to the operation target among the devices 60a, 60b, . . . , and 60m in the second device group 60 via the network 80.

In FIG. 1, the number of device servers 70 is one. However, if there is a plurality of types of the devices 60a, 60b, . . . , and 60m to be operated by the device server 70 (rather than in accordance with commands from the analysis server 20), a number of device servers 70 equal to the number of types are preferably present.

In addition, when all of the devices 60a, 60b, . . . , and 60m are operable with commands from the analysis server 20, the device server 70 may not be present.

### (1-7) Infrared Output Device

The infrared output device 40 has a storage unit (not illustrated) that stores an infrared signal pattern for control for each of the devices 50a, 50b, . . . , and 50n in the first device group 50 or for each of the operations to be performed on the devices 50a, 50b, . . . , and 50n in the first device group 50. The infrared output device 40 transmits an infrared signal to the operation target among the devices 50a, 50b, . . . , and 50n in the first device group 50 in accordance with a command transmitted from the analysis server 20 by using the infrared signal pattern stored in the storage unit.

### (2) Indoor Unit of Air Conditioner

The indoor unit 12 of the air conditioner 10 will further be described with reference to the drawings (with reference to mainly FIG. 2 through FIG. 5B).

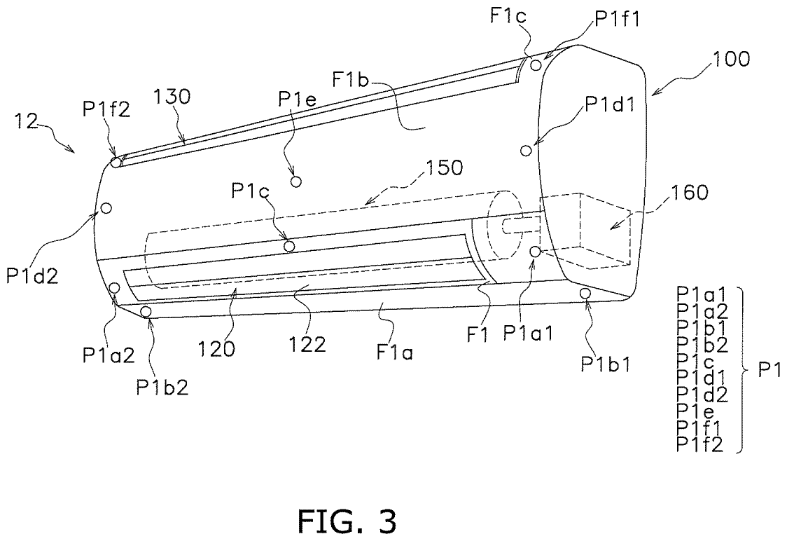

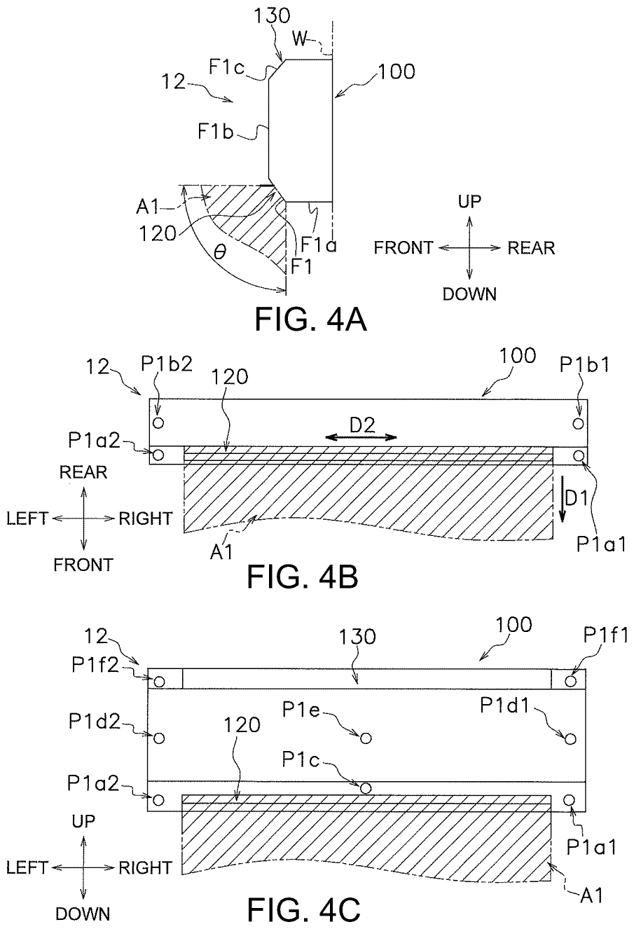

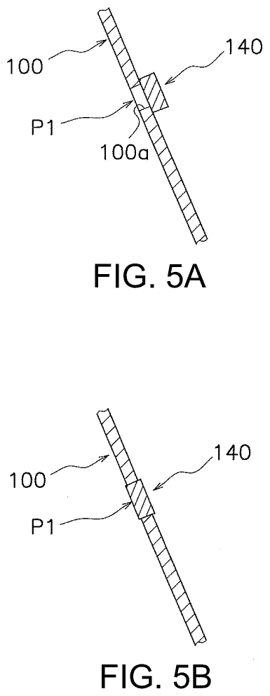

FIG. 3 is a schematic perspective view of the indoor unit 12 of the air conditioner 10. FIGS. 4A-4C include schematic illustrations of the blow-out of air from a blow-out port 120 in a main body 100 of the indoor unit 12 described below. FIG. 4A is a view of the main body 100, as viewed from one side, FIG. 4B is a view of the main body 100, as viewed from below, and FIG. 4C is a view of the main body 100, as viewed from the front. FIGS. 5A-5B include schematic illustrations exemplifying how each of the microphone elements 140 is attached to the main body 100 of the indoor unit 12.

In the following, expressions sometimes used to describe directions or orientations, such as “front (front face)”, “rear (rear face)”, “left”, “right”, “up”, and “down”, are indicated by the arrows in the drawings unless otherwise stated.

The indoor unit 12 is of a wall-mounted type. That is, the indoor unit 12 has a rear surface attached to a wall W (see FIG. 4A).

The indoor unit 12 has the main body 100, the microphone elements 140, the fan 150, the fan motor 160, and the module 180 into which the control board 18a and the voice processing chip 170 are integrated with each other (see FIG. 2 and FIG. 3).

The main body 100 is a housing accommodating therein an indoor-side heat exchanger (not illustrated), the fan 150, and the fan motor 160.

The main body 100 has formed therein the blow-out port 120 and a suction port 130 (see FIG. 3).

The suction port 130 is an opening through which air in the space to be air-conditioned is sucked into the main body 100. The suction port 130 extends with its longitudinal direction corresponding to the left-right direction. The suction port 130 is formed so as to extend from the top of the front face of the main body 100 to an upper surface of the main body 100 (see FIGS. 4A-4C).

The blow-out port 120 is an opening through which air-conditioned air is blown out into the space to be air-conditioned. The blow-out port 120 is formed in a lower surface of the main body 100. The lower surface of the main body 100 is a surface that is visible when the main body 100 is seen from below (directly below). Specifically, the blow-out port 120 is formed in a blow-out port forming surface F1 in a lower portion on the front side of the main body 100. As in FIG. 4A, the blow-out port forming surface F1 is an inclined surface (a surface inclined relative to the vertical plane) that leans rearward as it becomes lower in position. The blow-out port 120 is formed so as to extend with its longitudinal direction corresponding to a second direction D2 (here, the left-right direction) (see FIG. 4B and FIG. 4C). A flap 122 is arranged in the blow-out port 120 to adjust the up-down direction of airflow (see FIG. 3).

The air blown out from the blow-out port 120 mainly flows through a ventilation space A1 (see FIGS. 4A-4C). The ventilation space A1 is a space extending from the blow-out port 120 in such a manner as to have approximately the same width in the left-right direction as the width of the blow-out port 120. No consideration is given here of any change in the direction of airflow using an airflow-direction adjustment louver (not illustrated) for adjusting the left-right direction of airflow. In a case where the left-right direction of airflow is adjusted using the airflow-direction adjustment louver, the ventilation space A1 is a space that extends in the left-right direction toward the front. Further, the ventilation space A1 is a space that extends in a range defined by an angle θ in side view. Here, the ventilation space A1 extends between the horizontal plane and the vertical plane, for example, with the angle θ being approximately 90°. Note that the value of the angle θ changes in accordance with the shape of the flap 122 or the movable range of the flap 122. The blow-out port 120 is configured such that air is mainly blown out in a first direction D1 (forward) in bottom view (see FIG. 4B).

The fan 150 is used to suck air toward the inside of the main body 100 from the suction port 130 and to blow out air-conditioned air, which has exchanged heat with refrigerant within the indoor heat exchanger (not illustrated), from the blow-out port 120. The fan 150 is, for example, a cylindrical cross-flow fan. The fan 150 is disposed inside the main body 100 so as to extend in the left-right direction (the second direction D2 that is the longitudinal direction of the blow-out port 120) (see FIG. 3).

The fan 150 is driven by the inverter-controlled fan motor 160. The fan motor 160 is arranged on one side (here, the right side) of the inside of the main body 100 in the left-right direction (the second direction D2 that is the longitudinal direction of the blow-out port 120). More specifically, the fan motor 160 is disposed at one end (here, the right end) of the inside of the main body 100 in the left-right direction (see FIG. 3). Although not illustrated in the drawings, the module 180 (a module into which the control board 18a and the voice processing chip 170 are integrated with each other) is disposed at the right end of the inside of the main body 100 of the fan motor 160.

The microphone elements 140 are devices that accept voice instructions. The indoor unit 12 may have one microphone element 140, and preferably have a plurality of microphone elements 140.

The microphone elements 140 are arranged inside the main body 100 (see FIG. 5A), or are arranged on the main body 100 in such a manner as to face the space to be air-conditioned (see FIG. 5B).

When the microphone elements 140 are arranged inside the main body 100, the main body 100 has formed therein openings 100a near the microphone elements 140 (for example, at an adjacent position) (see FIG. 5A). While one opening 100a is depicted in FIG. 5A, a plurality of openings 100a may be formed. The microphone elements 140 use the openings 100a as voice capturing portions P1 and accept voice instructions captured from the voice capturing portions P1.

When the microphone elements 140 are arranged on the main body 100 in such a manner as to face the space to be air-conditioned, the microphone elements 140 use portions facing the space to be air-conditioned (for example, cover portions that cover diaphragms sensing voice to the microphone elements 140) as the voice capturing portions P1 and accept voice instructions captured from the voice capturing portions P1.

The voice capturing portions P1 are preferably arranged at positions where the microphone elements 140 can acquire high-quality voice instructions (less noisy voice instructions). Further, the voice capturing portions P1 are preferably arranged at positions where the microphone elements 140 can acquire voice instructions issued by an operator even if the sound volume of the voice instructions is low or the operator is located at a position away from the microphone elements 140. The arrangement of the voice capturing portions P1 in this respect will be described below.

### (2-1) Arrangement of Voice Capturing Portions

The voice capturing portions P1 are arranged at positions that deviate from the ventilation space A1 through which the air blown out from the blow-out port 120 in the main body 100 flows. The arrangement of the voice capturing portions P1 at positions that deviate from the ventilation space A1 makes it likely that less noisy voice instructions are acquired. The arrangement of the voice capturing portions P1 at positions that deviate from the ventilation space A1 also makes it likely that voice instructions are acquired even if the sound volume of the voice instructions is low or the operator is located at a position away from the microphone elements 140.

Note that it is preferable that the voice capturing portions P1 not be arranged on the left or right side surface or the rear surface of the main body 100. This is because, for example, although the left and right side surfaces of the main body 100 are located at positions that deviate from the ventilation space A1, the indoor unit 12 may often be arranged such that either the left or right side surface of the main body 100 adjoins the wall, in which case the microphone elements 140 are less likely to capture voice.

Preferably, the voice capturing portions P1 are generally arranged at positions satisfying one or more of the following conditions (A) to (E).
(A) A voice capturing portion is preferably disposed in a lower surface of the main body at a location other than the downstream side of the blow-out port in the direction in which air is blown out from a blow-out port (the first direction D1) in bottom view.
(B) A voice capturing portion is preferably disposed in a second surface of the main body that intersects a blow-out port forming surface in which a blow-out port is formed.
(C) A voice capturing portion is preferably disposed on the extension of the blow-out port in the second direction D2 (the longitudinal direction of blow-out port).
(D) A voice capturing portion is preferably disposed on the main body between the blow-out port and a suction port.
(E) A voice capturing portion is preferably disposed on a surface that intersects both the vertical plane and the horizontal plane and that is visible in bottom view.

In the wall-mounted type indoor unit 12, furthermore, preferably, the voice capturing portions P1 are generally arranged also taking into account the following conditions (E) to (G).
(F) A voice capturing portion is preferably disposed above the blow-out port in a center portion of the main body in the second direction D2 (the longitudinal direction of blow-out port). In particular, when the number of microphone elements is small (for example, when only one microphone element is used), a voice capturing portion preferably satisfies the condition (F).
(G) When two or more voice capturing portions are present, the voice capturing portions P1 are preferably disposed at both ends of the main body in the second direction D2 (the longitudinal direction of blow-out port).

Specifically, the arrangement of voice capturing portions P1a1, P1a2, P1b1, P1b2, P1c, Pld1, P1d2, P1e, P1f1, and P1f2 will be described as a variation of the arrangement of the voice capturing portions P1. The arrangement of these portions is illustrative, and the voice capturing portions P1 may be disposed at locations other than the exemplarily illustrated locations.

The indoor unit 12 may include one or two or more combinations each including a voice capturing portion and a microphone element 140 that accepts a voice instruction captured from the voice capturing portion. However, to accept voice instructions issued by voices in various directions, the number of combinations each including a voice capturing portion and a microphone element 140 that accepts a voice instruction captured from the voice capturing portion is preferably two or more. For example, the voice capturing portions P1 are preferably disposed at two or more positions among the positions P1a1, P1a2, P1b1, P1b2, P1c, P1d1, Pld2, P1e, P1f1, and P1f2 described below. The use of a plurality of (preferably, three or more) combinations each including a voice capturing portion and a microphone element 140 that accepts a voice instruction captured from the voice capturing portion allows the operator to identify a position from which a voice instruction is issued, which can be reflected in various control operations (such as delivering air to the position of the operator).

The voice capturing portions P1a1 and P1a2 are disposed on the extension of the blow-out port 120 in the second direction D2 that is the longitudinal direction of the blow-out port 120 (the left-right direction) (see FIG. 3). Further, the voice capturing portions P1a1 and P1a2 are disposed in the lower surface of the main body 100 at locations other than the downstream side of the blow-out port 120 in the first direction D1 (in the direction in which air is blown out from the blow-out port 120 in bottom view; here, forward) in bottom view (see FIG. 4B).

Further, the voice capturing portions P1a1 and P1a2 are disposed in the blow-out port forming surface F1 on the main body 100 that intersects both the vertical plane and the horizontal plane and that is visible in bottom view (see FIG. 4A). Further, the voice capturing portions P1a1 and P1a2 are disposed at ends of the main body 100 in the left-right direction (the second direction D2) (see FIG. 4B).

The voice capturing portions P1b1 and P1b2 are disposed in a surface F1a of the main body 100 that intersects the blow-out port forming surface F1 having the blow-out port 120 (see FIGS. 4A-4C). Specifically, whereas the blow-out port forming surface F1 is an inclined surface intersecting both the horizontal plane and the vertical plane, the surface F1a is approximately the horizontal plane. Further, the voice capturing portions P1b1 and P1b2 are disposed in the lower surface of the main body 100 at locations other than the downstream side of the blow-out port 120 in the first direction D1 in bottom view (see FIG. 4B). Further, the voice capturing portions P1a1 and P1a2 are disposed at ends of the main body 100 in the left-right direction (the second direction D2).

The voice capturing portion P1c is disposed in the blow-out port forming surface F1, which is the same as the surface having formed therein the blow-out port 120. The voice capturing portion P1c is disposed in the blow-out port forming surface F1 on the main body 100 that intersects both the vertical plane and the horizontal plane and that is visible in bottom view (see FIG. 4A). Further, the voice capturing portion P1c is disposed on the main body 100 between the blow-out port 120 and the suction port 130 (see FIG. 4C). Further, the voice capturing portion P1c is disposed above the blow-out port 120 in a center portion of the main body 100 in the left-right direction (the second direction D2) (see FIG. 4C).

The voice capturing portions P1d1 and P1d2 are disposed on a surface F1b of the main body 100 that intersects the blow-out port forming surface F1 having the blow-out port 120 (see FIGS. 4A-4C). Specifically, whereas the blow-out port forming surface F1 is an inclined surface intersecting both the horizontal plane and the vertical plane, the surface F1b is approximately the vertical plane. Further, the voice capturing portions Pld1 and P1d2 are disposed at ends of the main body 100 in the left-right direction (the second direction D2) (see FIG. 4C).

The voice capturing portion P1e is disposed on the surface F1b of the main body 100 that intersects the blow-out port forming surface F1 having the blow-out port 120 (see FIGS. 4A-4C). Specifically, whereas the blow-out port forming surface F1 is an inclined surface intersecting both the horizontal plane and the vertical plane, the surface F1b is approximately the vertical plane. Further, the voice capturing portion P1e is disposed on the main body 100 between the blow-out port 120 and the suction port 130 (see FIG. 4C). To reduce the susceptibility to the sound of airflow, the voice capturing portion P1e is preferably arranged on the main body 100 between the blow-out port 120 and the suction port 130 at a position where the distances to the blow-out port 120 and the suction port 130 are substantially equal, or is preferably arranged nearer the suction port 130. Further, the voice capturing portion P1e is disposed above the blow-out port 120 in a center portion of the main body 100 in the left-right direction (the second direction D2) (see FIG. 4C).

The voice capturing portions P1f1 and P1f2 are disposed on a surface F1c of the main body 100 that intersects the blow-out port forming surface F1 having the blow-out port 120 (see FIGS. 4A-4C). Specifically, whereas the blow-out port forming surface F1 is an inclined surface that leans rearward as it becomes lower in position, the surface F1c is an inclined surface that leans forward as it becomes lower in position (see FIG. 4A). Further, the voice capturing portions P1f1 and P1f2 are disposed at ends of the main body 100 in the left-right direction (the second direction D2) (see FIG. 4C).

The voice capturing portions P1a2, P1b2, P1d2, and P1f2 are disposed on the side of the main body 100 opposite to the side on which the fan motor 160 is disposed in the left-right direction (the second direction D2). Specifically, whereas the voice capturing portions P1a2, P1b2, P1d2, and P1f2 are disposed to the left (at the left end) of the main body 100, the fan motor 160 is disposed to the right (at the right end) of the main body 100. The location of the voice capturing portion P1a2 at this position makes the microphone element 140 less susceptible not only to the sound of the air blown out from the blow-out port 120 but also to the sound of the fan motor 160.

In terms of a reduced amount of the wiring task during assembling of the indoor unit 12, like the voice capturing portions P1a1, P1b1, P1d1, and P1f1, voice capturing portions may be disposed on the same side of the main body 100 as the side on which the fan motor 160 is disposed (the side on which electric components including the module 180 are arranged) in the left-right direction (the second direction D2).

### (3) Features of Air Conditioner

(3-1)

The air conditioner 10 according to the first embodiment includes the indoor unit 12, the transmission unit 16a, and the reception unit 16b. The indoor unit 12 has the main body 100 and the microphone elements 140. The main body 100 has formed therein the blow-out port 120 through which air-conditioned air is blown out toward the space to be air-conditioned. The microphone elements 140 accept a voice instruction captured from the voice capturing portions P1. The voice capturing portions P1 are arranged at positions that deviate from the ventilation space A1 through which the air blown out from the blow-out port 120 flows, in such a manner as to face the space to be air-conditioned. The transmission unit 16a transmits the signal S that is based on the voice instruction accepted by the microphone elements 140 to the outside. The reception unit 16b receives the command C corresponding to the signal S transmitted from the transmission unit 16a from the outside.

In the indoor unit 12 of the air conditioner 10, a portion for capturing voice instructions is arranged at a position that deviates from the ventilation space A1 through which the air blown out from the blow-out port 120 flows. This makes input of voice instructions to the microphone elements 140 less susceptible to blowing noise, and the microphone elements 140 can acquire less noisy voice instructions. Even if a voice spoken by an operator is weak, the microphone elements 140 are likely to acquire a clear voice instruction. A command based on the voice instruction is generated outside the air conditioner 10 on the basis of the acquired clear voice instruction, and is transmitted to the air conditioner 10. Thus, for example, even if diversity instructions are given to the air conditioner 10 by voice, malfunction of the air conditioner 10 (in a case where an operation different from that indicated in a voice instruction given from the operator is performed, including a case where a voice instruction given from the operator is not recognized) is less likely to occur.

Here, a functional unit that converts the signal S based on voice into the command C is disposed outside the air conditioner 10, and the air conditioner 10 does not need to individually have this function. Thus, a reduction in the cost of the air conditioner 10 can be achieved.

(3-2)

In the air conditioner 10 according to the first embodiment, the blow-out port 120 is formed in the lower surface of the main body 100, through which air is blown out in the first direction D1 (forward) in bottom view. The voice capturing portions P1a1, P1a2, P1b1, and P1b2 are disposed in the lower surface of the main body 100 at locations other than the downstream side of the blow-out port 120 in the first direction D1 in bottom view. Here, the voice capturing portions P1 can be disposed without the intervention of the ventilation space A1, and the microphone elements 140 are likely to acquire a clear voice instruction.

(3-3)

In the air conditioner 10 according to the first embodiment, the blow-out port 120 is formed in the blow-out port forming surface F1 of the main body 100. The blow-out port forming surface F1 is an example of a first surface. The voice capturing portions P1b1, P1b2, P1d1, P1d2, P1e, P1f1, and P1f2 are disposed in the surfaces F1a, F1b, and F1c of the main body 100, which intersect the blow-out port forming surface F1. The surfaces F1a, F1b, and F1c are examples of a second surface.

Here, since the voice capturing portions P1 are disposed in a surface intersecting the surface having formed therein the blow-out port 120, the voice capturing portions P1 can be disposed without the intervention of the ventilation space A1, and the microphone elements 140 are likely to acquire a clear voice instruction.

(3-4)

In the air conditioner 10 according to the first embodiment, the blow-out port 120 is formed in the main body 100 so as to extend with its longitudinal direction corresponding to the second direction D2 (the left-right direction). The voice capturing portions P1a1 and P1a2 are disposed on the extension of the blow-out port 120 in the second direction D2.

Here, the voice capturing portions P1 can be disposed without the intervention of the ventilation space A1, and the microphone elements 140 are likely to acquire a clear voice instruction.

(3-5)

In the air conditioner 10 according to the first embodiment, the main body 100 has formed therein the suction port 130 through which air is sucked from the space to be air-conditioned. The voice capturing portions P1c and P1e are disposed on the main body 100 between the blow-out port 120 and the suction port 130.

Here, the voice capturing portions P1 can be disposed without the intervention of the ventilation space A1, and the microphone elements 140 are likely to acquire a clear voice instruction.

(3-6)

In the air conditioner 10 according to the first embodiment, the voice capturing portions P1a1, P1a2, and P1c are disposed on the main body 100 in a surface that intersects both the vertical plane and the horizontal plane and that is visible in bottom view.

Here, the voice capturing portions P1 are disposed in a surface that is visible in bottom view (i.e., directed downwards) and that intersects both the vertical plane and the horizontal plane (in other words, an inclined surface). Thus, it is easy for the microphone elements 140 to more clearly acquire a voice instruction given from an operator in the space to be air-conditioned.

(3-7)

In the air conditioner 10 according to the first embodiment, the indoor unit 12 is of a wall-mounted type. The blow-out port 120 is formed so as to extend with its longitudinal direction corresponding to the second direction D2. The indoor unit 12 has the fan 150, and the fan motor 160 that drives the fan 150. The fan 150 is accommodated in the main body 100. The fan motor 160 is arranged on one side of the inside of the main body 100 in the second direction D2. The voice capturing portions P1a2, P1b2, P1d2, and P1f2 are disposed on the side of the main body 100 opposite to the side on which the fan motor is disposed in the second direction D2.

Here, the voice capturing portions P1 of the microphone elements 140 are disposed away from the fan motor 160. This makes the microphone elements 140 less susceptible to noise of the fan motor 160, and the microphone elements 140 are likely to acquire a clear voice instruction.

(3-8)

In the air conditioner 10 according to the first embodiment, the indoor unit 12 is of a wall-mounted type. The blow-out port 120 is formed so as to extend with its longitudinal direction corresponding to the second direction D2. The indoor unit 12 has the fan 150, and the fan motor 160 that drives the fan 150. The fan 150 is accommodated in the main body 100. The fan motor 160 is arranged on one side of the inside of the main body 100 in the second direction D2. The voice capturing portions P1 are disposed on the same side of the main body 100 as the side on which the fan motor 160 is disposed in the second direction D2.

Here, electric components including the microphone elements 140 and the fan motor 160 can be gathered and arranged on one side of the main body 100, reducing the man-hours in performing a wiring task during production of the indoor unit 12.

(3-9)

In the air conditioner 10 according to the first embodiment, the indoor unit 12 is of a wall-mounted type. The blow-out port 120 is formed so as to extend with its longitudinal direction corresponding to the second direction D2. The voice capturing portions P1c and P1e are disposed above the blow-out port 120 in a center portion of the main body 100 in the second direction D2.

Here, the voice capturing portions P1 are disposed in a center portion of the main body 100. Thus, even if the voice capturing portion P1 is disposed in only one location, voice can be acquired from various directions.

(3-10)

In the air conditioner 10 according to the first embodiment, the indoor unit 12 is of a wall-mounted type. The indoor unit 12 has two or more combinations each including a voice capturing portion P1 and a microphone element 140 that accepts a voice instruction captured from the voice capturing portion P1. The blow-out port 120 is formed so as to extend with its longitudinal direction corresponding to the second direction D2. The voice capturing portions P1 are disposed at least at both ends of the main body 100 in the second direction D2.

Here, the voice capturing portions P1 are disposed at least at both ends of the main body 100, and voice is thus easily acquired from various directions.

(3-11)

In the air conditioner 10 according to the first embodiment, the indoor unit 12 has the voice processing chip 170. The voice processing chip 170 is an example of a voice recognition chip. The voice processing chip 170 recognizes only a specific voice instruction among voice instructions acquired by the microphone elements 140 and generates the predetermined command C0. The transmission unit 16a transmits the signal S that is based on a voice instruction other than the specific voice instruction among the voice instructions accepted by the microphone elements 140 to the outside.

Here, the specific voice instruction can be converted into a command on the air conditioner 10 side without being transmitted to the outside. This enables quick operation in response to the specific instruction, and provides high convenience.

(3-12)

In the air conditioner 10 according to the first embodiment, the indoor unit 12 has the control board 18a that controls the operation of the indoor unit 12. The control board 18a and the voice processing chip 170 are integrated with each other.

Here, it is possible to reduce the man-hours in performing a wiring task during production of the indoor unit 12.

(3-13)

In the air conditioner 10 according to the first embodiment, the transmission unit 16a transmits the signal S to the analysis server 20, which analyzes the signal S, via the network 80. The analysis server 20 is an example of an analysis apparatus. The reception unit 16b receives the command C generated on the basis of the result of analysis of the signal S by the analysis server 20.

Here, the signal S that is based on a voice instruction is transmitted to the external analysis server 20, and the command C is generated on the basis of the result of analysis of the signal S. Thus, even if the air conditioner 10 is caused to execute a relatively complex operation, the air conditioner 10 can be operated by voice.

In addition, it is also easy to operate multiple types of devices including the air conditioner 10 (the devices in the first device group 50 and the second device group 60) by voice input to the microphone elements 140.

(3-14)

In the air conditioner 10 according to the first embodiment, the transmission unit 16a transmits the information J on the state quantity for at least one of the air conditioner 10 and the space to be air-conditioned to the air conditioner server 30. The air conditioner server 30 is an example of a command generation apparatus. The reception unit 16b receives the command C, which is generated by the air conditioner server 30 on the basis of the result of analysis of the signal S by the analysis server 20 and on the basis of the information J on the state quantity.

Here, an instruction is given to the air conditioner 10 on the basis of the result of analysis of the signal S that is based on a voice instruction and on the basis of the state quantity for the air conditioner 10 or the space to be air-conditioned, and thus it is likely that appropriate control of the air conditioner 10 is executed.

### Second Embodiment

An air conditioner 10 according to a second embodiment will be described. The air conditioner 10 according to the second embodiment is the same as the air conditioner 10 of the first embodiment, except for an indoor unit 12a, and thus the components other than indoor unit 12b will not be described. In addition, a device control system 1 including the air conditioner 10 is similar to that in the first embodiment and will not be described.

As in the second embodiment, an air conditioner 10 according to a third embodiment through a seventh embodiment described below is the same as the air conditioner 10 of the first embodiment, except for an indoor unit, and thus the description of the components other than the indoor unit (including the description of a device control system 1 including the air conditioner 10) is omitted without mention in particular.

### (1) Indoor Unit of Air Conditioner

The indoor unit 12a of the air conditioner 10 will be described with reference to FIG. 2 and FIG. 6 to FIG. 9.

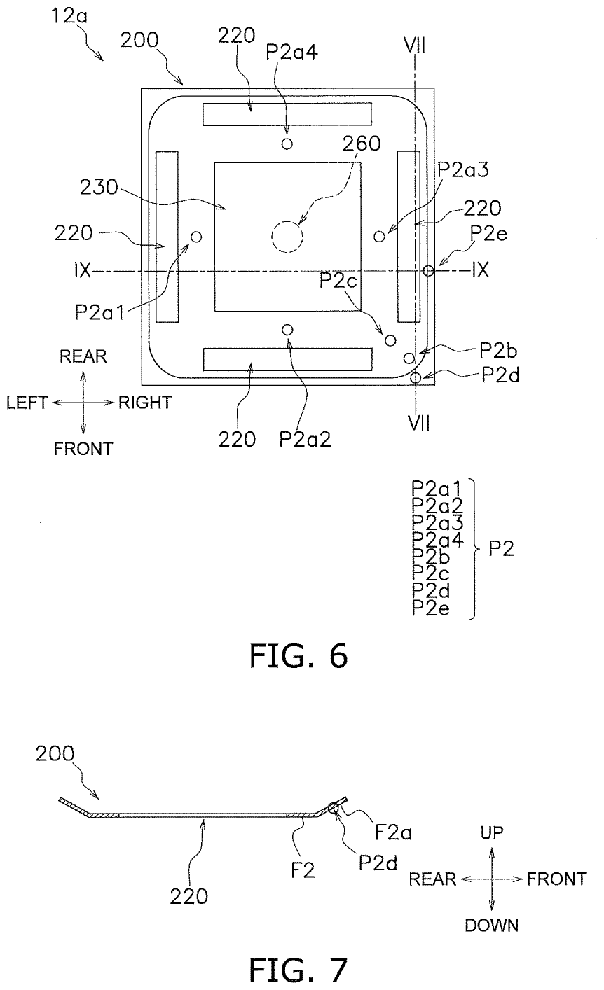

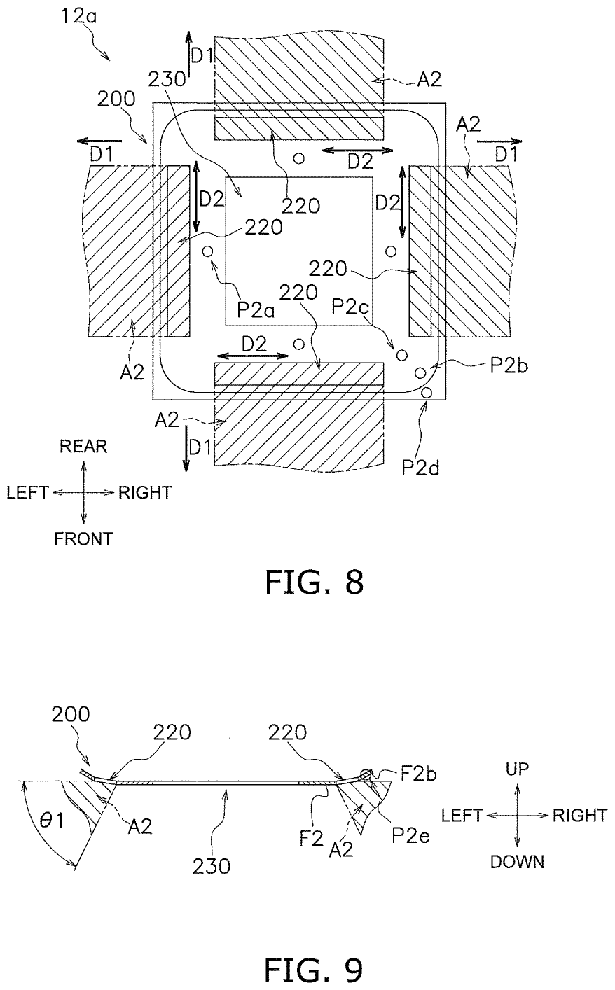

FIG. 6 is a schematic bottom view of the indoor unit 12a of the air conditioner 10. FIG. 7 is a schematic sectional view taken along the VII-VII cross-section of FIG. 6. FIG. 8 is a schematic illustration of the blow-out of air from blow-out ports 220 in a main body 200 of the indoor unit 12a when the main body 200 is viewed from below. FIG. 9 is a schematic sectional view taken along the IX-IX cross-section of FIG. 6. In FIG. 7 and FIG. 9, the illustration of the internal devices of the main body 200 of the indoor unit 12a is omitted.

In the following, expressions sometimes used to describe directions or orientations, such as “front (front face)”, “rear (rear face)”, “left”, “right”, “up”, and “down”, are indicated by the arrows in the drawings unless otherwise stated.

The indoor unit 12a is a ceiling-embedded unit. The indoor unit 12a is a unit having the blow-out ports 220 at four locations, through which air is blown out in four directions (see FIG. 8).

The indoor unit 12a has the main body 200, microphone elements 140, a fan (not illustrated), and a fan motor 260 (see FIG. 2 and FIG. 6).

The main body 200 is a housing accommodating therein an indoor-side heat exchanger (not illustrated), the fan (not illustrated), and the fan motor 260. The main body 200 has formed therein the blow-out ports 220 and a suction port 230 (see FIG. 6).

The suction port 230 is an opening through which air in the space to be air-conditioned is sucked into the main body 200. The suction port 230 is formed into a square shape (see FIG. 6). The suction port 230 is formed in a center portion of the main body 200 in bottom view (see FIG. 6).

The blow-out ports 220 are openings through which air-conditioned air is blown out into the space to be air-conditioned. The blow-out ports 220 are formed at four locations on a lower surface of the main body 200. The lower surface of the main body 200 is a surface that is visible when the main body 200 is seen from below (directly below). Specifically, the blow-out ports 220 are formed in a blow-out port forming surface F2 of the main body 200 so as to extend along the four sides of the square-shaped main body 200 in bottom view in the vicinity of the front edge, the rear edge, the left edge, and the right edge. The blow-out port forming surface F2 is approximately the horizontal plane. The blow-out ports 220 are formed so as to surround the suction port 230 arranged in the center portion of the main body 200 in bottom view. Each of the blow-out ports 220 is formed so as to extend with its longitudinal direction corresponding to the second direction D2 (the left-right direction or the front-rear direction) (see FIG. 8). A flap (not illustrated) is arranged in each of the blow-out ports 220 to adjust the up-down direction of airflow.

The air blown out from the blow-out ports 220 mainly flows through a ventilation space A2 (see FIG. 8). The ventilation space A2 is a space extending from the blow-out ports 220 in such a manner as to have approximately the same width in the respective longitudinal directions, or in the second direction D2 (the left-right direction or the front-rear direction), as the width of the blow-out ports 220. No consideration is given here of any change in the direction of airflow using an airflow-direction adjustment louver (not illustrated) for adjusting the direction of airflow in the second direction D2. In a case where the direction of airflow in the second direction D2 is adjusted using the airflow-direction adjustment louver, the ventilation space A2 is a space that extends in the respective longitudinal directions of the blow-out ports 220 (the second direction D2) as the distances from the blow-out ports 220 increase. Further, the ventilation space A2 is a space that extends in a range defined by an angle Olin side view. The angle θ1 is smaller than 90°. Note that the value of the angle θ1 changes in accordance with the shape of the flaps (not illustrated) disposed in the blow-out ports or the movable ranges of the flaps. The blow-out ports 220 are configured such that air is mainly blown out in the first direction D1 (outward from the main body 200; in the direction away from the suction port 230) in bottom view (see FIG. 4B).

The fan motor 260 is an inverter-controlled motor that drives the fan (not illustrated) so that air is sucked toward the inside of the main body 200 from the suction port 230 and air-conditioned air, which has exchanged heat with refrigerant within the indoor heat exchanger (not illustrated), is blown out from the blow-out ports 220. The fan motor 260 is arranged inside the main body 200 in a center portion of the main body 200 in bottom view.

Like the microphone elements 140 of the first embodiment, the microphone elements 140 are arranged inside the main body 200 or are arranged on the main body 200 in such a manner as to face the space to be air-conditioned. The microphone elements 140 accept a voice instruction captured from voice capturing portions P2. The arrangement of the voice capturing portions P2 will be described below.

### (1-1) Arrangement of Voice Capturing Portions

Like the voice capturing portions P1 of the first embodiment, the voice capturing portions P2 are arranged at positions that deviate from the ventilation space A2 through which the air blown out from the blow-out ports 220 in the main body 200 flows. Further, the voice capturing portions P2 are preferably arranged at positions that satisfy one or more of the conditions (A) to (E) described in the first embodiment.

Specifically, the arrangement of voice capturing portions P2a1, P2a2, P2a3, P2a4, P2b, P2c, P2d, and P2e will be described as a variation of the arrangement of the voice capturing portions P2. While, for simplicity of description, P2b, P2c, and P2d are provided only in one corner of the square-shaped main body 200 in bottom view, which is not intended to be limiting, similar voice capturing portions P2 may be disposed in the other three corners. The voice capturing portion P2e may also be disposed at the front edge, the rear edge, and the left edge in addition to the right edge of the main body 200. The arrangement of the voice capturing portions P2a1, P2a2, P2a3, P2a4, P2b, P2c, P2d, and P2e is illustrative, and the voice capturing portions P2 may be disposed at locations other than the exemplarily illustrated locations.

In the indoor unit 12a, the number of combinations each including a voice capturing portion and a microphone element 140 that accepts a voice instruction captured from the voice capturing portion may be one or two or more, and is preferably two or more.

The voice capturing portions P2a1 to P2a4 are disposed in the blow-out port forming surface F2 having formed therein the blow-out ports 220. Further, the voice capturing portions P2a1 to P2a4 are disposed in the lower surface of the main body 200 at locations other than the downstream side of the blow-out ports 220 in the first direction D1 (in the direction in which air is blown out from the blow-out ports 220 in bottom view; here outward (in the direction away from the suction port 230)) in bottom view (see FIG. 8). In other words, the voice capturing portions P2a1 to P2a4 are disposed in an area of the main body 200 closer to the center than the blow-out ports 220 (see FIG. 8). Further, the voice capturing portions P2a1 to P2a4 are disposed on the main body 200 between the blow-out ports 220 and the suction port 230 (see FIG. 8). To reduce the susceptibility to the sound of airflow, the voice capturing portions P2a1 to P2a4 are preferably arranged on the main body 200 between the blow-out ports 220 and the suction port 230 at positions where the distances to the blow-out ports 220 and the suction port 230 are substantially equal, or are preferably arranged nearer the suction port 230.

The voice capturing portion P2b is disposed on the extension of the blow-out ports 220 in the second direction D2 (the longitudinal direction of the blow-out ports 220) (see FIG. 8). Further, the voice capturing portion P2b is disposed in the lower surface of the main body 200 at a location other than the downstream side of the blow-out ports 220 in the direction in which air is blown out from the blow-out ports 220 (the first direction D1) in bottom view (see FIG. 8).

The voice capturing portion P2c is disposed in the blow-out port forming surface F2 having formed therein the blow-out ports 220. Further, the voice capturing portion P2c is disposed in the lower surface of the main body 200 at a location other than the downstream side of the blow-out ports 220 in the direction in which air is blown out from the blow-out ports 220 (the first direction D1) in bottom view (see FIG. 8). The voice capturing portion P2c is arranged between two blow-out ports 220 (see FIG. 8). Preferably, the voice capturing portion P2c is arranged at a position where the distances from the two adjacent blow-out ports 220 are equal (see FIG. 8).

The voice capturing portion P2d is disposed in a surface F2a of the main body 200 that intersects the blow-out port forming surface F2 having formed therein the blow-out ports 220 (see FIG. 8). Further, the voice capturing portion P2d is disposed on the main body 200 in the surface F2a that intersects both the vertical plane and the horizontal plane and that is visible in bottom view (see FIG. 7). Further, the voice capturing portion P2d is disposed in the lower surface of the main body 200 at a location other than the downstream side of the blow-out ports 220 in the direction in which air is blown out from the blow-out ports 220 (the first direction D1) in bottom view (see FIG. 8).

The voice capturing portion P2e is disposed in the lower surface of the main body 200 on the downstream side of the blow-out ports 220 in the direction in which air is blown out from the blow-out ports 220 (the first direction D1) in bottom view. Note that the voice capturing portion P2e is disposed at a position higher than the blow-out ports 220 (a position near the surface of the ceiling on which the indoor unit 12a is mounted) (see FIG. 9). Further, the voice capturing portion P2e is provided at a higher position than that of the ventilation space A2 (see FIG. 9). Further, the voice capturing portion P2e is disposed in a surface F2b of the main body 200 that intersects the blow-out port forming surface F2 having formed therein the blow-out ports 220 (see FIG. 9). Further, the voice capturing portion P2e is disposed on the main body 200 in the surface F2b that intersects both the vertical plane and the horizontal plane and that is visible in bottom view (see FIG. 9).

Among the voice capturing portions described above, in particular, the voice capturing portions P2b, P2c, and P2d are arranged in a corner of the square-shaped main body 200 in bottom view, and are arranged at positions relatively away from the fan motor 260 arranged in the center portion of the main body 200. This prevents not only the sound of the air blown out from the blow-out ports 220 but also the sound of the fan motor 260 from affecting the quality of voice instructions acquired by the microphone elements 140.

### (2) Features of Air Conditioner

The air conditioner 10 of the second embodiment also has a feature similar to the feature (3-1) described for the air conditioner 10 of the first embodiment. Further, the air conditioner 10 of the second embodiment can also have features similar to the features (3-2) to (3-6) described for the air conditioner 10 of the first embodiment in accordance with the arrangement of the voice capturing portions P2. Further, the air conditioner 10 of the second embodiment also has features similar to the features (3-11) to (3-14) described for the air conditioner 10 of the first embodiment.

### Third Embodiment

An air conditioner 10 according to a third embodiment will be described.

### (1) Indoor Unit of Air Conditioner

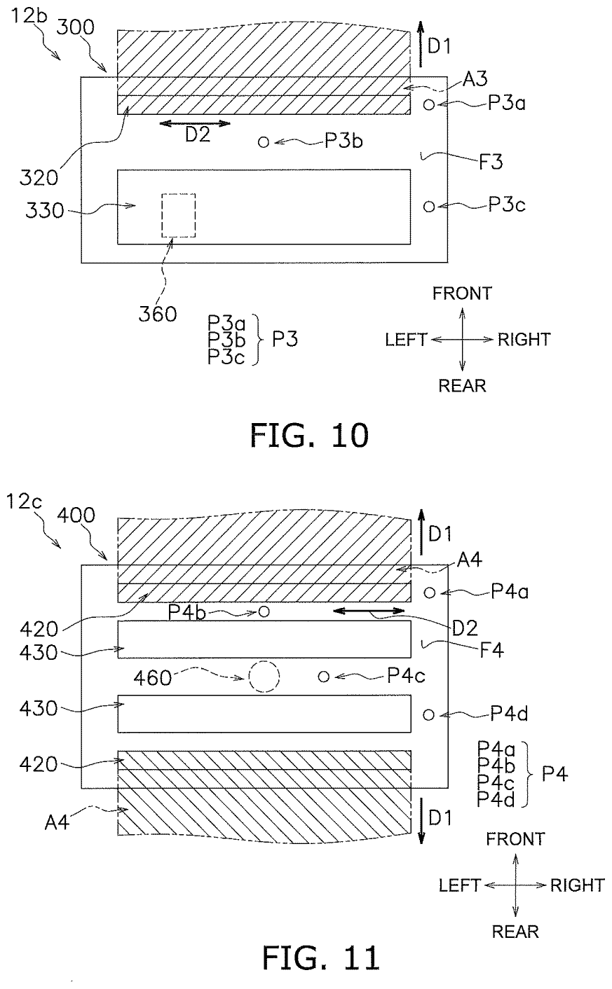

An indoor unit 12b of the air conditioner 10 will be described with reference to FIG. 2 and FIG. 10. FIG. 10 is a schematic bottom view of the indoor unit 12b of the air conditioner 10.

In the following, expressions sometimes used to describe directions or orientations, such as “front (front face)”, “rear (rear face)”, “left”, and “right”, are indicated by the arrows in the drawings unless otherwise stated.

The indoor unit 12b is a ceiling-embedded unit. The indoor unit 12b is a unit that blows out air in one direction (see FIG. 10).

The indoor unit 12b has a main body 300, microphone elements 140, a fan (not illustrated), and a fan motor 360 (see FIG. 2 and FIG. 10).

The main body 300 is a housing accommodating therein an indoor-side heat exchanger (not illustrated), the fan (not illustrated), and the fan motor 360. The main body 300 has formed therein a blow-out port 320 and a suction port 330 (see FIG. 10).

The suction port 330 is an opening through which air in the space to be air-conditioned is sucked into the main body 200. The suction port 330 is formed into a rectangular shape whose longitudinal direction corresponds to the left-right direction in bottom view (see FIG. 10). The suction port 330 is formed in a blow-out port forming surface F3. The suction port 330 is formed nearer the rear of the main body 200 in bottom view (see FIG. 10).

The blow-out port 320 is an opening through which air-conditioned air is blown out into the space to be air-conditioned. The blow-out port 320 is formed in a lower surface of the main body 300 nearer the front of the main body 300. The lower surface of the main body 300 is a surface that is visible when the main body 300 is seen from below (directly below). Specifically, the blow-out port 320 is formed in the blow-out port forming surface F3. The blow-out port forming surface F3 is approximately the horizontal plane. The blow-out port 320 is formed so as to extend with its longitudinal direction corresponding to the second direction D2 (the left-right direction) (see FIG. 10). A flap (not illustrated) is arranged in the blow-out port 320 to adjust the up-down direction of airflow.

The air blown out from the blow-out port 320 mainly flows through a ventilation space A3 (see FIG. 10). The ventilation space A3 is a space extending from the blow-out port 320 in such a manner as to have approximately the same width in its longitudinal direction, or in the second direction D2, as the width of the blow-out port 220. No consideration is given here of any change in the direction of airflow using an airflow-direction adjustment louver (not illustrated) for adjusting the direction of airflow in the second direction D2. In a case where the direction of airflow in the second direction is adjusted using the airflow-direction adjustment louver, the ventilation space A3 is a space that extends in the longitudinal direction of the blow-out port 320 (the second direction D2) as the distance from the blow-out port 320 increases. Further, the ventilation space A3 is a space that extends in a range defined by a predetermined angle in front of the blow-out port 320 in side view. The angle range changes in accordance with the shape of the flap (not illustrated) disposed in the blow-out port or the movable range of the flap. The blow-out port 320 is configured such that air is mainly blown out in the first direction D1 (forward; in the direction away from the suction port 330) in bottom view (see FIG. 10).

The fan motor 360 is an inverter-controlled motor that drives the fan (not illustrated) so that air is sucked toward the inside of the main body 300 from the suction port 330 and air-conditioned air, which has exchanged heat with refrigerant within the indoor heat exchanger (not illustrated), is blown out from the blow-out port 320. The fan motor 360 is arranged inside the main body 300 in the left rear of the main body 300 (see FIG. 10).

Like the microphone elements 140 of the first embodiment, the microphone elements 140 are arranged inside the main body 300 or are arranged on the main body 300 in such a manner as to face the space to be air-conditioned. The microphone elements 140 accept a voice instruction captured from voice capturing portions P3. The arrangement of the voice capturing portions P3 will be described below.

### (1-1) Arrangement of Voice Capturing Portions

Like the voice capturing portions P1 of the first embodiment, the voice capturing portions P3 are arranged at positions that deviate from the ventilation space A3 through which the air blown out from the blow-out port 320 in the main body 300 flows. Further, the voice capturing portions P3 are preferably arranged at positions that satisfy one or more of the conditions (A) to (E) described in the first embodiment.

Specifically, the arrangement of voice capturing portions P3a, P3b, and P3c will be described as a variation of the arrangement of the voice capturing portions P3. While, for simplicity of description, the voice capturing portions P3a and P3c are provided only on one side (right side) in the second direction D2, which is not intended to be limiting, similar voice capturing portions P3 may be disposed on the other side (left side) in the second direction D2. The arrangement of the voice capturing portions P3a, P3b, and P3c is illustrative, and the voice capturing portions P3 may be disposed at locations other than the exemplarily illustrated locations.

In the indoor unit 12b, the number of combinations each including a voice capturing portion and a microphone element 140 that accepts a voice instruction captured from the voice capturing portion may be one or two or more, and is preferably two or more.

The voice capturing portion P3a is disposed in the blow-out port forming surface F3 having formed therein the blow-out port 320. The voice capturing portion P3a is disposed on the extension of the blow-out port 320 in the second direction D2 (see FIG. 10). Further, the voice capturing portion P3a is disposed in the lower surface of the main body 300 at a location other than the downstream side of the blow-out port 320 in the direction in which air is blown out from the blow-out port 320 (the first direction D1) in bottom view (see FIG. 10).

The voice capturing portion P3b is disposed in the blow-out port forming surface F3 having formed therein the blow-out port 320. The voice capturing portion P3b is disposed in the lower surface of the main body 300 at a location other than the downstream side of the blow-out port 320 in the direction in which air is blown out from the blow-out port 320 (the first direction D1) in bottom view (see FIG. 10). Further, the voice capturing portion P3b is disposed on the main body 300 between the blow-out port 320 and the suction port 330 (see FIG. 10). To reduce the susceptibility to the sound of airflow, the voice capturing portion P3b is preferably arranged on the main body 300 between the blow-out port 320 and the suction port 330 at a position where the distances to the blow-out port 320 and the suction port 330 are substantially equal, or is preferably arranged nearer the suction port 330. Further, the voice capturing portion P3b is disposed in a center portion in the second direction D2 (the left-right direction) (see FIG. 10).

The voice capturing portion P3c is disposed in the blow-out port forming surface F3 having formed therein the blow-out port 320 (see FIG. 10). The voice capturing portion P3c is disposed in the lower surface of the main body 300 at a location other than the downstream side of the blow-out port 320 in the direction in which air is blown out from the blow-out port 320 (the first direction D1) in bottom view (see FIG. 10). The voice capturing portion P3c is disposed on the extension of the suction port 330 in the longitudinal direction of the suction port 330 (see FIG. 10).

When consideration is also given of the influences of the sound of the fan motor 360, the voice capturing portion P3 is preferably arranged at a position (for example, to the right or left front) relatively away from the fan motor 360 arranged in the left rear of the main body 300.

### (2) Features of Air Conditioner

The air conditioner 10 of the third embodiment also has a feature similar to the feature (3-1) described for the air conditioner 10 of the first embodiment. Further, the air conditioner 10 of the third embodiment can also have features similar to the features (3-2), (3-4), and (3-5) described for the air conditioner 10 of the first embodiment in accordance with the arrangement of the voice capturing portions P3. In addition, a portion or the entirety of the blow-out port forming surface F3 is inclined, and the inclined surface is provided with the voice capturing portions P3, thereby achieving features similar to the features (3-3) and (3-6) described for the air conditioner 10 of the first embodiment. Further, the air conditioner 10 of the third embodiment has features similar to the features (3-10) to (3-14) described for the air conditioner 10 of the first embodiment.

### Fourth Embodiment

An air conditioner 10 according to a fourth embodiment will be described.

### (1) Indoor Unit of Air Conditioner

An indoor unit 12c of the air conditioner 10 will be described with reference to FIG. 2 and FIG. 11. FIG. 11 is a schematic bottom view of the indoor unit 12c of the air conditioner 10.

In the following, expressions sometimes used to describe directions or orientations, such as “front (front face)”, “rear (rear face)”, “left”, and “right”, are indicated by the arrows in the drawings unless otherwise stated.

The indoor unit 12c is a ceiling-embedded unit. The indoor unit 12c is a unit that blows out air in two directions (forward and rearward) (see FIG. 11).

The indoor unit 12c has a main body 400, microphone elements 140, a fan (not illustrated), and a fan motor 460 (see FIG. 2 and FIG. 11).

The main body 400 is a housing accommodating therein an indoor-side heat exchanger (not illustrated), the fan (not illustrated), and the fan motor 460. The main body 400 has formed therein blow-out ports 420 and suction ports 430 (see FIG. 11).

The suction ports 430 are openings through which air in the space to be air-conditioned is sucked into the main body 400. The suction ports 430 are formed in a blow-out port forming surface F4. The suction ports 430 are formed in two locations in the front and rear of the main body 400 (see FIG. 11). Each of the suction ports 430 is formed into a rectangular shape whose longitudinal direction corresponds to the left-right direction in bottom view (see FIG. 11). The blow-out ports 420 are openings through which air-conditioned air is blown out into the space to be air-conditioned. The blow-out ports 420 are formed in a lower surface of the main body 400 in the front and rear of the main body 400. The lower surface of the main body 400 is a surface that is visible when the main body 400 is seen from below (directly below). Specifically, the blow-out ports 420 are formed in the blow-out port forming surface F4. The blow-out port forming surface F4 is approximately the horizontal plane. The blow-out ports 420 are formed so as to extend with their longitudinal directions corresponding to the second direction D2 (the left-right direction) (see FIG. 11). A flap (not illustrated) is arranged in each of the blow-out ports 420 to adjust the up-down direction of airflow.

The air blown out from the blow-out ports 420 mainly flows through ventilation spaces A4 (see FIG. 11). The ventilation spaces A4 are spaces extending from the blow-out ports 420 in such a manner as to have approximately the same width in the respective longitudinal directions, or in the second direction D2, as the width of the blow-out ports 420. No consideration is given here of any change in the direction of airflow using an airflow-direction adjustment louver (not illustrated) for adjusting the direction of airflow in the second direction D2. In a case where the direction of airflow in the second direction is adjusted using the airflow-direction adjustment louver, the ventilation spaces A4 are spaces that extend in the respective longitudinal directions of the blow-out ports 420 (the second direction D2) as the distances from the blow-out ports 420 increase. Further, the ventilation spaces A4 are spaces that extend toward the blowing-out directions of the blow-out ports 420 in a range defined by a predetermined angle in side view. The angle range changes in accordance with the shape of the flaps (not illustrated) disposed in the blow-out ports or the movable ranges of the flaps. The blow-out ports 420 are configured such that air is mainly blown out in the first direction D1 (forward and rearward) in bottom view (see FIG. 11). The blow-out ports 420 are configured such that air is blown out toward the outside of the main body 400 (in the direction away from the suction ports 430) (see FIG. 11).

The fan motor 460 is an inverter-controlled motor that drives the fan (not illustrated) so that air is sucked toward the inside of the main body 400 from the suction ports 430 and air-conditioned air, which has exchanged heat with refrigerant within the indoor heat exchanger (not illustrated), is blown out from the blow-out ports 420. The fan motor 460 is arranged inside the main body 400 in a center portion of the main body 400 in bottom view (see FIG. 11).

Like the microphone elements 140 of the first embodiment, the microphone elements 140 are arranged inside the main body 400 or are arranged on the main body 400 in such a manner as to face the space to be air-conditioned. The microphone elements 140 accept a voice instruction captured from voice capturing portions P4. The arrangement of the voice capturing portions P4 will be described below.

### (1-1) Arrangement of Voice Capturing Portions

Like the voice capturing portions P1 of the first embodiment, the voice capturing portions P4 are arranged at positions that deviate from the ventilation spaces A4 through which the air blown out from the blow-out ports 420 in the main body 400 flows. Further, the voice capturing portions P4 are preferably arranged at positions that satisfy one or more of the conditions (A) to (E) described in the first embodiment.

Specifically, the arrangement of voice capturing portions P4a, P4b, P4c, and P4d will be described as an example variation of the arrangement of the voice capturing portions P4. While, for simplicity of description, the voice capturing portions P4a, P4c, and P4d are provided only on one side (right side) in the second direction D2, which is not intended to be limiting, similar voice capturing portions P4 may be provided on the other side (left side) in the second direction D2. The arrangement of the voice capturing portions P4a, P4b, P4c, and P4d is illustrative, and the voice capturing portions P4 may be disposed at locations other than the exemplarily illustrated locations.

In the indoor unit 12c, the number of combinations each including a voice capturing portion and a microphone element 140 that accepts a voice instruction captured from the voice capturing portion may be one or two or more, and is preferably two or more.

The voice capturing portion P4a is disposed in the blow-out port forming surface F4 having formed therein the blow-out ports 420. The voice capturing portion P4a is disposed on the extension of one of the blow-out ports 420 in the second direction D2 (see FIG. 11). Further, the voice capturing portion P4a is disposed in the lower surface of the main body 400 at a location other than the downstream side of the blow-out ports 420 in the directions in which air is blown out from the blow-out ports 420 (the first direction D1) in bottom view (see FIG. 11).

The voice capturing portions P4b and P4c are disposed in the blow-out port forming surface F4 having formed therein the blow-out ports 420. The voice capturing portions P4b and P4c are disposed in the lower surface of the main body 400 at locations other than the downstream side of the blow-out ports 420 in the directions in which air is blown out from the blow-out ports 420 (the first direction D1) in bottom view (see FIG. 11).

Further, the voice capturing portion P4b is disposed on the main body 400 between one of the blow-out ports 420 and one of the suction ports 430 (see FIG. 11). To reduce the susceptibility to the sound of airflow, the voice capturing portion P4b is preferably arranged on the main body 400 between one of the blow-out ports 420 and one of the suction ports 430 at a position where the distances to the blow-out port 420 and the suction port 430 are substantially equal, or is preferably arranged nearer the suction port 430. Further, the voice capturing portion P4b is disposed in a center portion in the second direction D2 (the left-right direction) (see FIG. 11).

The voice capturing portion P4c is disposed on the main body 400 between the two suction ports 430 (see FIG. 11). To reduce the susceptibility to the sound of airflow, the voice capturing portion P4c is preferably arranged on the main body 400 between the two suction ports 430 at a position where the distances from the two suction ports 430 are substantially equal. In addition, to reduce the susceptibility to the sound of the fan motor 460, the voice capturing portion P4c is preferably disposed at a position away from the center portion (near the fan motor 460) in the second direction D2 (the left-right direction) (see FIG. 11).

The voice capturing portion P4d is disposed in the blow-out port forming surface F4 having formed therein the blow-out ports 420 (see FIG. 11). The voice capturing portion P4d is disposed in the lower surface of the main body 400 at a location other than the downstream side of the blow-out ports 420 in the directions in which air is blown out from the blow-out ports 420 (the first direction D1) in bottom view (see FIG. 11). The voice capturing portion P4d is disposed on the extension of one of the suction ports 430 in the longitudinal direction of the suction port 430 (see FIG. 11).

### (2) Features of Air Conditioner

The air conditioner 10 of the fourth embodiment also has a feature similar to the feature (3-1) described for the air conditioner 10 of the first embodiment. Further, the air conditioner 10 of the fourth embodiment can also have features similar to the features (3-2), (3-4), and (3-5) described for the air conditioner 10 of the first embodiment in accordance with the arrangement of the voice capturing portions P4. In addition, a portion or the entirety of the blow-out port forming surface F4 is inclined, and the inclined surface is provided with the voice capturing portions P4, thereby achieving features similar to the features (3-3) and (3-6) described for the air conditioner 10 of the first embodiment. Further, the air conditioner 10 of the fourth embodiment has features similar to the features (3-10) to (3-14) described for the air conditioner 10 of the first embodiment.

### Fifth Embodiment

An air conditioner 10 according to a fifth embodiment will be described.

### (1) Indoor Unit of Air Conditioner

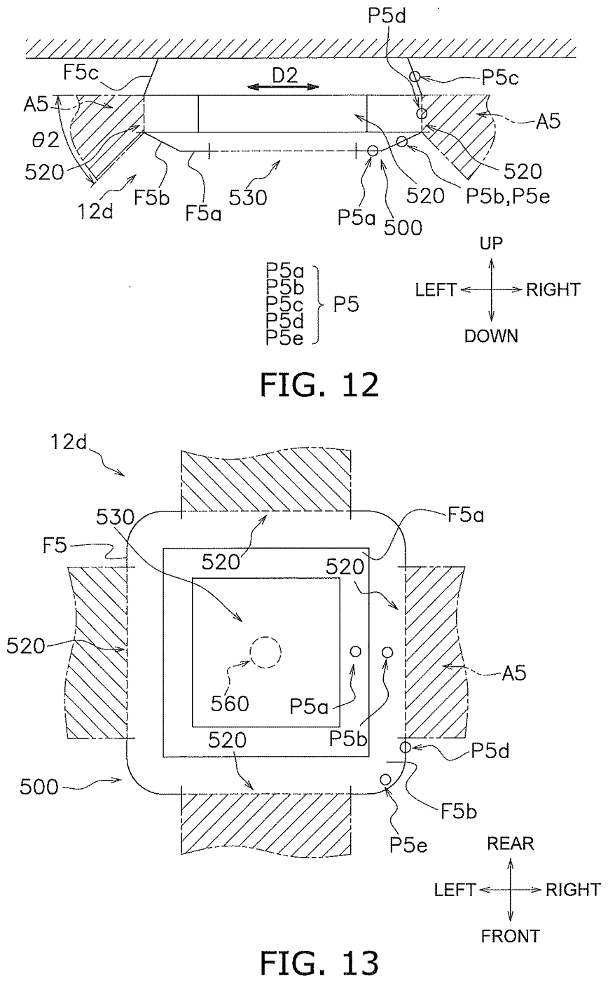

An indoor unit 12d of the air conditioner 10 will be described with reference to FIG. 2, FIG. 12, and FIG. 13.

FIG. 12 is a schematic side view of the indoor unit 12d of the air conditioner 10. FIG. 13 is a schematic bottom view of the indoor unit 12d of the air conditioner 10.

In the following, expressions sometimes used to describe directions or orientations, such as “front (front face)”, “rear (rear face)”, “left”, “right”, “up”, and “down”, are indicated by the arrows in the drawings unless otherwise stated.

The indoor unit 12d is a ceiling-suspended unit. The indoor unit 12d is a unit having blow-out ports 520 at four locations, through which air is blown out in four directions (see FIG. 13).

The indoor unit 12d has a main body 500, microphone elements 140, a fan (not illustrated), and a fan motor 560 (see FIG. 2 and FIG. 13).

The main body 500 is a housing accommodating therein an indoor-side heat exchanger (not illustrated), the fan (not illustrated), and the fan motor 560. The main body 500 has formed therein the blow-out ports 520 and a suction port 530 (see FIG. 13).

The suction port 530 is an opening through which air in the space to be air-conditioned is sucked into the main body 500. The suction port 530 is formed into a square shape (see FIG. 13). The suction port 530 is formed in a center portion of the main body 500 in bottom view (see FIG. 13).

The blow-out ports 520 are openings through which air-conditioned air is blown out into the space to be air-conditioned. The blow-out ports 520 are formed in a front side surface, a rear side surface, a right side surface, and a left side surface of the main body 500. The blow-out ports 520 are formed in a blow-out port forming surface F5 so as to extend in the left-right direction or the front-rear direction. The blow-out port forming surface F5 is the vertical plane. A flap (not illustrated) is arranged in each of the blow-out ports 520 to adjust the up-down direction of airflow.

The air blown out from the blow-out ports 520 mainly flows through ventilation spaces A5 (see FIG. 12 and FIG. 13). The ventilation spaces A5 are spaces extending from the blow-out ports 520 in such a manner as to have approximately the same width in the respective longitudinal directions, or in the second direction D2 (the left-right direction or the front-rear direction), as the width of the blow-out ports 520. No consideration is given here of any change in the direction of airflow using an airflow-direction adjustment louver (not illustrated) for adjusting the direction of airflow in the second direction D2. In a case where the direction of airflow in the second direction D2 is adjusted using the airflow-direction adjustment louver, the ventilation spaces A5 are spaces that extend in the respective longitudinal directions of the blow-out ports 520 (the second direction D2) as the distances from the blow-out ports 520 increase. Further, the ventilation spaces A5 are spaces that extend in a range defined by an angle θ2 in side view. The angle θ2 is smaller than 90°. Note that the value of the angle θ2 changes in accordance with the shape of the flaps (not illustrated) disposed in the blow-out ports or the movable ranges of the flaps. The blow-out ports 520 are configured such that air is blown out in the direction away from the main body 500 (see FIG. 13).

The fan motor 560 is an inverter-controlled motor that drives the fan (not illustrated) so that air is sucked toward the inside of the main body 500 from the suction port 530 and air-conditioned air, which has exchanged heat with refrigerant within the indoor heat exchanger (not illustrated), is blown out from the blow-out ports 520. The fan motor 560 is arranged inside the main body 500 in a center portion of the main body 500 in bottom view.

Like the microphone elements 140 of the first embodiment, the microphone elements 140 are arranged inside the main body 500 or are arranged on the main body 500 in such a manner as to face the space to be air-conditioned. The microphone elements 140 accept a voice instruction captured from voice capturing portions P5. The arrangement of the voice capturing portions P5 will be described below.

### (1-1) Arrangement of Voice Capturing Portions

Like the voice capturing portions P1 of the first embodiment, the voice capturing portions P5 are arranged at positions that deviate from the ventilation spaces A5 through which the air blown out from the blow-out ports 520 in the main body 500 flows. Further, the voice capturing portions P5 are preferably arranged at positions that satisfy one or more of the conditions (A) to (E) described in the first embodiment.

Specifically, the arrangement of voice capturing portions P5a, P5b, P5c, P5d, and P5e will be described as a variation of the arrangement of the voice capturing portions P5. The arrangement of the voice capturing portions P5a, P5b, P5c, P5d, and P5e is illustrative, and the voice capturing portions P5 may be disposed at locations other than the exemplarily illustrated locations. For example, without limitation, in FIG. 13, all of the voice capturing portions P5a, P5b, P5c, P5d, and P5e are arranged at the right side of the main body 500. The voice capturing portions P5 may be disposed in the left, front, and rear of the main body 500 at positions corresponding to the voice capturing portions P5a, P5b, P5c, P5d, and P5e provided in FIG. 13.

In the indoor unit 12d, the number of combinations each including a voice capturing portion and a microphone element 140 that accepts a voice instruction captured from the voice capturing portion may be one or two or more, and is preferably two or more.

The voice capturing portion P5a is formed in a surface F5a having formed therein the suction port 530 (see FIG. 12). The voice capturing portion P5a is disposed in the surface F5a of the main body 500 that intersects the blow-out port forming surface F5 having formed therein the blow-out ports 520 (see FIG. 12). The voice capturing portion P5b is disposed on the main body 500 between one of the blow-out ports 520 and the suction port 530 (see FIG. 12).

The voice capturing portions P5b and P5e are disposed in a surface F5b intersecting the blow-out port forming surface F5 having formed therein the blow-out ports 520 (see FIG. 12). The voice capturing portions P5b and P5e are disposed in the surface F5b that intersects both the vertical plane and the horizontal plane and that is visible in bottom view (see FIG. 12).

The voice capturing portion P5b is disposed on the main body 500 between one of the blow-out ports 520 and the suction port 530 (see FIG. 13). Preferably, the voice capturing portion P5b is arranged on the main body 500 between one of the blow-out ports 520 and the suction port 530 at a position where the distances to the blow-out port 520 and the suction port 530 are substantially equal, or is preferably arranged nearer the suction port 530. Further, the voice capturing portion P4b is disposed in a center portion in the second direction D2 (in FIG. 13, in the front-rear direction) of adjacent blow-out ports 520.

The voice capturing portion P5e is arranged in a corner of the square-shaped main body 500 in bottom view and is arranged at a position relatively away from the fan motor 560 arranged in the center portion of the main body 500. Thus, when a voice capturing portion is located at the position P5e, not only the sound of the air blown out from the blow-out ports 520 but also the sound of the fan motor 560 is less likely to affect the quality of voice instructions acquired by the microphone elements 140.

The voice capturing portion P5d is disposed in the blow-out port forming surface F5 having formed therein the blow-out ports 520. The voice capturing portion P5d is disposed on the extension of one of the blow-out ports 520 in the longitudinal direction of the blow-out port 520, or in the second direction D2 (in FIG. 13, the front-rear direction).

The voice capturing portion P5c is disposed in a surface F5c of the main body 500 that intersects the blow-out port forming surface F5 having formed therein the blow-out ports 520. Specifically, whereas the blow-out port forming surface F5 is the vertical plane, the surface F5c is an inclined surface.

### (2) Features of Air Conditioner

The air conditioner 10 of the fifth embodiment also has a feature similar to the feature (3-1) described for the air conditioner 10 of the first embodiment. Further, the air conditioner 10 of the fifth embodiment can also have features similar to the features (3-3) to (3-6) described for the air conditioner 10 of the first embodiment in accordance with the arrangement of the voice capturing portions P5. Further, the air conditioner 10 of the fifth embodiment has features similar to the features (3-10) to (3-14) described for the air conditioner 10 of the first embodiment.

### Sixth Embodiment

An air conditioner 10 according to a sixth embodiment will be described.

### (1) Indoor Unit of Air Conditioner

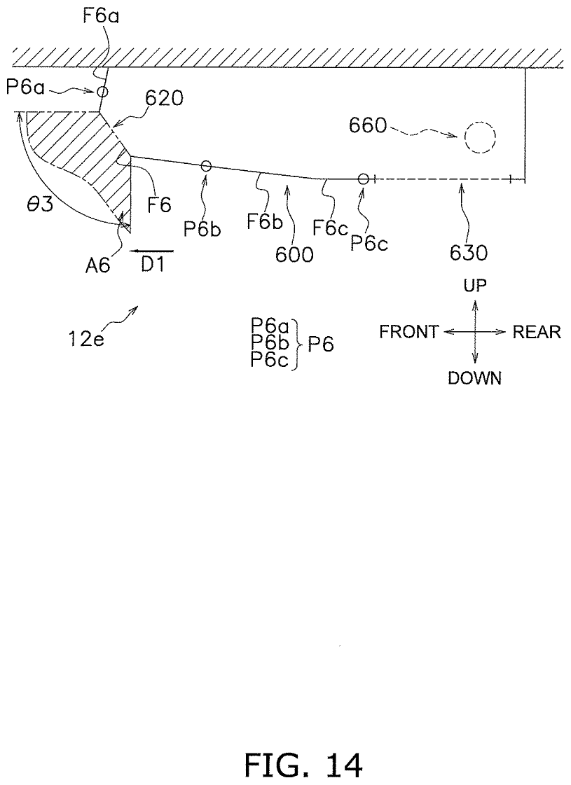

An indoor unit 12e of the air conditioner 10 will be described with reference to FIG. 2 and FIG. 14.

FIG. 14 is a schematic side view of the indoor unit 12e of the air conditioner 10.

In the following, expressions sometimes used to describe directions or orientations, such as “front (front face)”, “rear (rear face)”, “up”, and “down”, are indicated by the arrows in the drawings unless otherwise stated.

The indoor unit 12e is a ceiling-suspended unit. The indoor unit 12e is a unit that blows out air in one direction (forward) (see FIG. 14).

The indoor unit 12e has a main body 600, microphone elements 140, a fan (not illustrated), and a fan motor 660 (see FIG. 2 and FIG. 14).

The main body 600 is a housing accommodating therein an indoor-side heat exchanger (not illustrated), the fan (not illustrated), and the fan motor 660. The main body 600 has formed therein a blow-out port 620 and a suction port 630 (see FIG. 14).

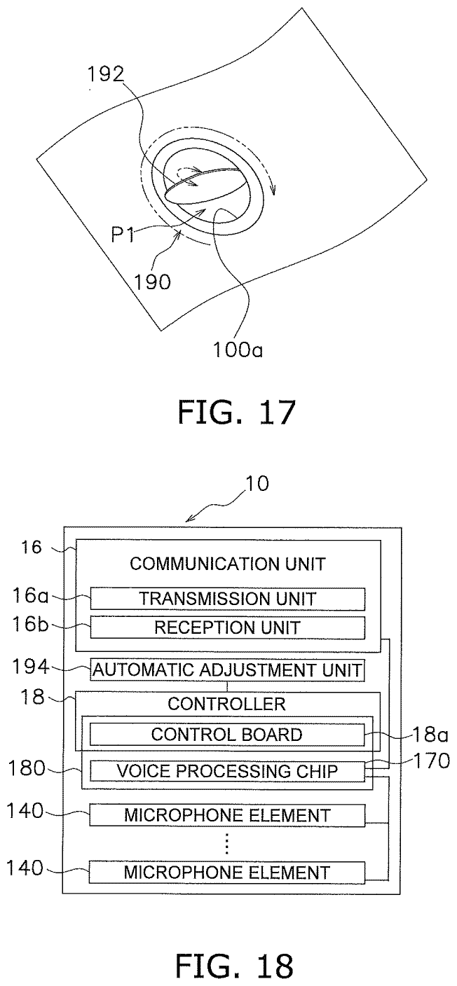

The suction port 630 is an opening through which air in the space to be air-conditioned is sucked into the main body 600. The suction port 630 is formed in a bottom surface of the main body 600 nearer the rear of the main body 600 (see FIG. 17). The suction port 630 is formed into a rectangular shape whose longitudinal direction corresponds to the left-right direction (the horizontal direction that is perpendicular to the front-rear direction) (see FIG. 14).

The blow-out port 620 is an opening through which air-conditioned air is blown out into the space to be air-conditioned. The blow-out port 620 is formed in a front lower portion of the main body 600. The blow-out port 620 is formed in a blow-out port forming surface F6 so as to extend in the left-right direction (the horizontal direction that is perpendicular to the front-rear direction). A flap (not illustrated) is arranged in the blow-out port 620 to adjust the up-down direction of airflow.

The air blown out from the blow-out port 620 mainly flows through a ventilation space A6 (see FIG. 14). The ventilation space A6 is a space extending from the blow-out port 620 in such a manner as to have approximately the same width in its longitudinal direction, or the left-right direction, as the width of the blow-out port 620. No consideration is given here of any change in the direction of airflow using an airflow-direction adjustment louver (not illustrated) for adjusting the left-right direction of airflow. In a case where the left-right direction of airflow is adjusted using the airflow-direction adjustment louver, the ventilation space A6 is a space that extends in the left-right direction as the distance from the blow-out port 620 increases. Further, the ventilation space A6 is a space that extends in a range defined by an angle θ3 in side view. Here, the angle θ3 is about 90°. Note that the value of the angle θ3 changes in accordance with the shape of the flap (not illustrated) disposed in the blow-out port or the movable range of the flap. The blow-out port 620 is configured such that air is mainly blown out in the first direction D1 (forward) in bottom view (see FIG. 14).

The fan motor 660 is an inverter-controlled motor that drives the fan (not illustrated) so that air is sucked toward the inside of the main body 600 from the suction port 630 and air-conditioned air, which has exchanged heat with refrigerant within the indoor heat exchanger (not illustrated), is blown out from the blow-out port 620. The fan motor 660 is arranged inside the main body 600 nearer the rear of the main body 600 (see FIG. 14).

Like the microphone elements 140 of the first embodiment, the microphone elements 140 are arranged inside the main body 600 or are arranged on the main body 600 in such a manner as to face the space to be air-conditioned. The microphone elements 140 accept a voice instruction captured from voice capturing portions P6. The arrangement of the voice capturing portions P6 will be described below.

### (1-1) Arrangement of Voice Capturing Portions

Like the voice capturing portions P1 of the first embodiment, the voice capturing portions P6 are arranged at positions that deviate from the ventilation space A6 through which the air blown out from the blow-out port 620 in the main body 600 flows. Further, the voice capturing portions P6 are preferably arranged at positions that satisfy one or more of the conditions (A) to (E) described in the first embodiment.

Specifically, the arrangement of voice capturing portions P6a, P6b, and P6c will be described as a variation of the arrangement of the voice capturing portions P6. The arrangement of P6a, P6b, and P6c is illustrative, and the voice capturing portions P6 may be disposed at locations other than the exemplarily illustrated locations.

In the indoor unit 12e, the number of combinations each including a voice capturing portion and a microphone element 140 that accepts a voice instruction captured from the voice capturing portion may be one or two or more, and is preferably two or more.

The voice capturing portion P6a is disposed in a surface F6a of the main body 600 that intersects the blow-out port forming surface F6 having formed therein the blow-out port 620 (see FIG. 14).

The voice capturing portion P6b is disposed in a surface F6b of the main body 600 that intersects the blow-out port forming surface F6 having formed therein the blow-out port 620 (see FIG. 14). Further, the voice capturing portion P6b is disposed on the main body 600 between the blow-out port 620 and the suction port 630 (see FIG. 14). Further, the voice capturing portion P6b is disposed on the main body 600 in the surface F6b that intersects both the vertical plane and the horizontal plane and that is visible in bottom view (see FIG. 14).

The voice capturing portion P6c is disposed in a surface F6c of the main body 600 that intersects the blow-out port forming surface F6 having formed therein the blow-out port 620 (see FIG. 14). Further, the voice capturing portion P6c is disposed on the main body 600 between the blow-out port 620 and the suction port 630 (see FIG. 14).

### (2) Features of Air Conditioner

The air conditioner 10 of the sixth embodiment also has a feature similar to the feature (3-1) described for the air conditioner 10 of the first embodiment. Further, the air conditioner 10 of the sixth embodiment can also have features similar to the features (3-2) to (3-6) described for the air conditioner 10 of the first embodiment in accordance with the arrangement of the voice capturing portions P6. Further, the air conditioner 10 of the sixth embodiment has features similar to the features (3-10) to (3-14) described for the air conditioner 10 of the first embodiment.

### Seventh Embodiment

An air conditioner 10 according to a seventh embodiment will be described.

### (1) Indoor Unit of Air Conditioner

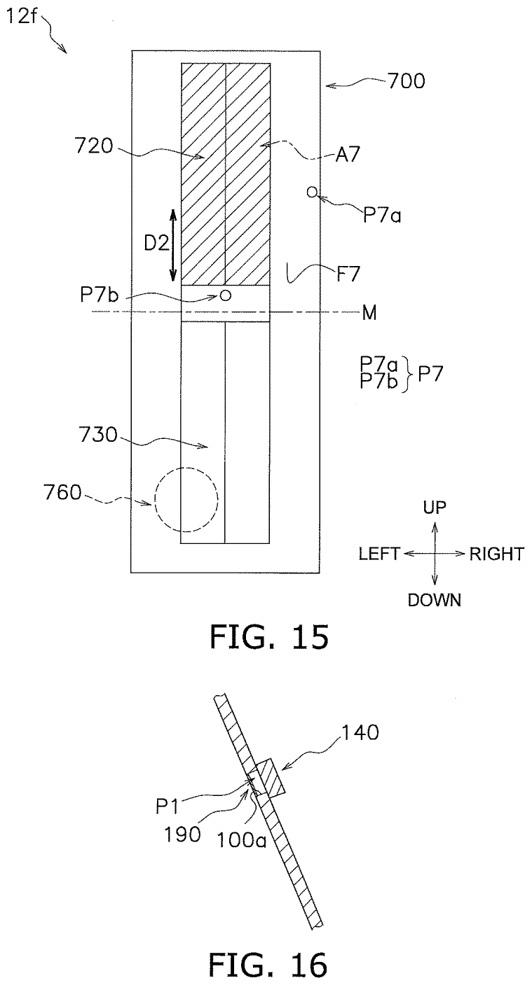

An indoor unit 12f of the air conditioner 10 will be described with reference to FIG. 2 and FIG. 15.

FIG. 15 is a schematic front view of the indoor unit 12f of the air conditioner 10.

In the following, expressions sometimes used to describe directions or orientations, such as “right”, “left”, “up”, and “down”, are indicated by the arrows in the drawings unless otherwise stated.

The indoor unit 12f is a floor-mounted unit that blows out air to the front (see FIG. 15).

The indoor unit 12f has a main body 700, microphone elements 140, a fan (not illustrated), and a fan motor 760 (see FIG. 2 and FIG. 15).

The main body 700 is a housing accommodating therein an indoor-side heat exchanger (not illustrated), the fan (not illustrated), and the fan motor 760. The main body 700 has formed therein a blow-out port 720 and a suction port 730 (see FIG. 15).

The suction port 730 is an opening through which air in the space to be air-conditioned is sucked into the main body 700. The suction port 730 is formed in a lower portion on the front of the main body 700 (see FIG. 15). The suction port 730 is also formed in lower portions on the right and left side surfaces of the main body 700 (not illustrated).

The blow-out port 720 is an opening through which air-conditioned air is blown out into the space to be air-conditioned. The blow-out port 720 is formed in an upper portion on the front of the main body 700. The blow-out port 720 is formed in a blow-out port forming surface F7. The blow-out port 720 extends with its longitudinal direction corresponding to the up-down direction (the second direction D2). A flap (not illustrated) is arranged in the blow-out port 720 to adjust the left-right direction of airflow.

The air blown out from the blow-out port 720 mainly flows through a ventilation space A7 (see FIG. 15). The ventilation space A7 is a space extending from the blow-out port 720 in such a manner as to have approximately the same width in the left-right direction as the width of the blow-out port 720. No consideration is given here of any change in the direction of airflow using an airflow-direction adjustment louver (not illustrated) for adjusting the left-right direction of airflow. In a case where the left-right direction of airflow is adjusted using the airflow-direction adjustment louver, the ventilation space A7 is a space that extends in the left-right direction as the distance from the blow-out port 720 increases. No consideration is given here of any change in the direction of airflow using an airflow-direction adjustment louver (not illustrated) for adjusting the up-down direction of airflow. In a case where the up-down direction of airflow is adjusted using the airflow-direction adjustment louver, the ventilation space A7 is a space that extends in the up-down direction as the distance from the blow-out port 720 increases.

The fan motor 760 is an inverter-controlled motor that drives the fan (not illustrated) so that air is sucked toward the inside of the main body 700 from the suction port 730 and air-conditioned air, which has exchanged heat with refrigerant within the indoor heat exchanger (not illustrated), is blown out from the blow-out port 720. The fan motor 760 is arranged in a lower portion of the main body 700.

Like the microphone elements 140 of the first embodiment, the microphone elements 140 are arranged inside the main body 700 or are arranged on the main body 700 in such a manner as to face the space to be air-conditioned. The microphone elements 140 accept a voice instruction captured from voice capturing portions P7. The arrangement of the voice capturing portions P7 will be described below.

### (1-1) Arrangement of Voice Capturing Portions

Like the voice capturing portions P1 of the first embodiment, the voice capturing portions P7 are arranged at positions that deviate from the ventilation space A7 through which the air blown out from the blow-out port 720 in the main body 700 flows.

Note that it is preferable that the voice capturing portions P7 not be arranged on the left or right side surface or the rear surface of the main body 700. This is because, for example, although the left and right side surfaces of the main body 700 are located at positions that deviate from the ventilation space A7, the indoor unit 12f may often be arranged such that either the left or right side surface of the main body 700 adjoins the wall, in which case the microphone elements 140 are less likely to capture voice.

Further, the voice capturing portions P7 are preferably arranged at positions that satisfy one or more of the conditions (A) to (E) described in the first embodiment. Further, the voice capturing portions P7 are preferably disposed above a center M (see FIG. 15) of the main body 700 in the height direction.

In the floor-mounted indoor unit 12f, as in FIG. 15, the fan motor 760, which is heavy, is generally arranged in a lower portion of the indoor unit 12f. In contrast, the voice capturing portions P7 are disposed in an upper portion of the indoor unit 12f (above the center M of the main body 700). Thus, the microphone elements 140 is less susceptible to the sound of the fan motor 760, and is likely to acquire a clear voice instruction. In addition, when the voice capturing portions P7 are disposed in a lower portion of the indoor unit 12f, a voice instruction given by a standing or seated operator can be impeded by obstacles (for example, furniture such as a table or chair). In contrast, here, the voice capturing portions P7 are disposed in an upper portion of the indoor unit 12f, and thus a voice instruction is likely to be captured through the voice capturing portion P7 without obstruction.

Specifically, the arrangement of voice capturing portions P7a and P7b will be described as a variation of the arrangement of the voice capturing portions P7. The arrangement of the voice capturing portions P7a and P7b is illustrative, and the voice capturing portions P7 may be disposed at locations other than the exemplarily illustrated locations. For example, while, for simplicity of description, the voice capturing portion P7a is disposed only on one side (right side) in the left-right direction, which is not intended to be limiting, a similar voice capturing portion P7 may be disposed on the other side (left side) in the left-right direction.

In the indoor unit 12f, the number of combinations each including a voice capturing portion and a microphone element 140 that accepts a voice instruction captured from the voice capturing portion may be one or two or more, and is preferably two or more.

The voice capturing portions P7a and P7b are disposed above the center M of the main body 700 in the height direction (see FIG. 15).

The voice capturing portion P7b is disposed on the main body 700 between the blow-out port 720 and the suction port 730 (see FIG. 15). Further, the voice capturing portion P7b is disposed on the extension of the blow-out port 720 in the longitudinal direction of the blow-out port 720, or in the second direction D2 (the up-down direction) (see FIG. 15).

### (2) Features of Air Conditioner

The air conditioner 10 of the seventh embodiment also has a feature similar to the feature (3-1) described for the air conditioner 10 of the first embodiment. Further, the air conditioner 10 of the seventh embodiment can also have features similar to the (3-1) and (3-3) to (3-6) described for the air conditioner 10 of the first embodiment in accordance with the arrangement of the voice capturing portions P3. Further, the air conditioner 10 of the seventh embodiment has features similar to the features (3-10) to (3-14) described for the air conditioner 10 of the first embodiment.

### <Modifications>

The following provides modifications of the first to seventh embodiments described above.

### (1) Modification 1A

In the configuration of any of the embodiments described above, the indoor unit 12 or 12a to 12f preferably further has a voice-capture-direction adjustment mechanism 190 capable of changing the directions in which voice is captured by the voice capturing portions P1 to P7.

For example, in the first embodiment, when the circular openings 100a are formed near (for example, at positions adjacent to) the microphone elements 140 of the main body 100 and the openings 100a function as the voice capturing portions P1, a plate member 192 for changing the voice-capture-direction (facilitating input of sound from a specific direction) is provided for each of the openings 100a (see FIG. 16). The plate member 192 changes the direction of travel of a sound wave by, for example, reflecting voice. The plate member 192 is made manually rotatable so as to allow a point thereon to enter the opening 100a and exit the opening 100a, and, in addition, the plate member 192 is made manually rotatable in the circumferential direction of the opening 100a. This enables the voice capturing portions P1 to P7 to change the directions in which voice is captured (see FIG. 17).

Since the direction in which voice is captured is made changeable, it is possible to avoid a failure of the direction of voice capturing being directed to a place where no person is generally present (for example, to the wall), regardless of the attachment position or the like of the indoor unit 12. In addition, since the direction in which voice is captured can be changed, microphone elements are likely to acquire a clear voice instruction even if a voice spoken by an operator is weak.

Further, for example, the indoor units 12 and 12a to 12f may further include a detection unit that detects the position of a person in the space to be air-conditioned. The voice-capture-direction adjustment mechanism 190 may have an automatic adjustment unit 194 (see FIG. 18) that automatically changes the directions in which voice is captured by the voice capturing portions P1 to P7 in accordance with a detection result of the detection unit.

Specifically, for example, the detection unit is implemented by a plurality of microphone elements 140 and may detect the position of a person (who has given voice) by determining from which voice capturing portion the voice instruction having the largest sound volume has been captured. Further, the indoor unit 12 or 12a to 12f may have a motion sensor that detects the movement of a heat generating object, and the motion sensor may be used to detect the position of a person. The controller 18 may be configured to control a motor, which is an example of the automatic adjustment unit 194, in accordance with the result of detecting a person to activate the plate member 192.

With the configuration described above, the direction of voice capturing is automatically changed in accordance with the position of a person in the space to be air-conditioned. Thus, it is easy for the microphone elements 140 to acquire a clear voice instruction anywhere an operator moves within the space to be air-conditioned.

While the activation of the plate member 192 mounted in the opening 100a serving as each of the voice capturing portions P1 to P7 has been described as an example of the voice-capture-direction adjustment mechanism 190, the aspect of the voice-capture-direction adjustment mechanism is not limited to this. For example, the voice-capture-direction adjustment mechanism 190 may be configured to change the directions of the microphone elements 140 to change the directions in which voice is captured by the voice capturing portions P1 to P7.

### (2) Modification 1B

In the embodiments described above, without limitation, the device control system 1 is a system capable of also controlling the operation of the first device group 50 and the second device group 60 by using voice instructions. The device control system 1 may be a system that does not control the operation of either the first device group 50 or the second device group 60 or does not control the operation of the first device group 50 or the second device group 60. The device groups 50 and 60 that are not operated by using voice instructions, or the infrared output device 40 and the device server 70, which are required to control the device groups 50 and 60, may not be included in the device control system 1.

### (3) Modification 1C

In the embodiments described above, without limitation, the analysis server 20, the air conditioner server 30, and the device server 70 in the device control system 1 are separate servers. For example, one server may function as the analysis server 20 and the air conditioner server 30, or function as the analysis server 20, the air conditioner server 30, and the device server 70.

Conversely, the function of each of the analysis server 20, the air conditioner server 30, and the device server 70 described in the above embodiments may be achieved by a plurality of servers rather than by a single server.

Furthermore, in the embodiments described above, without limitation, the signal S transmitted from the transmission unit 16a is received by the analysis server 20. For example, the transmission unit 16a may transmit the signal S to the air conditioner server 30, and the signal S may be transmitted from the air conditioner server 30 to the analysis server 20.

### (4) Modification 1D

In the embodiments described above, an air conditioner has been described, taking as an example an apparatus that mainly adjusts the temperature or humidity of air; however, the air conditioner is not limited to an apparatus of this type. The air conditioner may be an air cleaner that removes dust particles and the like from air and blows out cleaned air, an air-flow adjustment apparatus that adjusts the flow of air in the space to be air-conditioned, or the like.

### (5) Modification 1E

In the embodiments described above, the arrangement of the microphone elements 140 is determined, taking into account the sound of the air blown out from the blow-out port in the main body of the indoor unit of the air conditioner 10 and, further, preferably, the sound of the fan motor. More preferably, the arrangement of the microphone elements 140 is determined, taking into account not only these sound generation sources but also other sound generation sources that may affect the capture of voice instructions by the microphone elements 140. For example, when the indoor unit of the air conditioner 10 has a voice output unit (such as a speaker) that generates beep, buzzer, or any other sound, preferably, the microphone elements 140 are preferably disposed away from the voice output unit (for example, when voice output unit is placed to the right of the main body, the microphone elements 140 are arranged to the left of the main body).

Further, for example, when the indoor unit of the air conditioner 10 has a drive unit (such as a stepping motor) for activating a flap disposed in a blow-out port or the like or a movable unit in an automatic cleaning mechanism for a filter, preferably, the microphone elements 140 are preferably disposed away from the drive unit (for example, when the drive unit is placed in an upper portion of the indoor unit, the microphone elements 140 are arranged in a lower portion of the main body).

Further, for example, when the indoor unit of the air conditioner 10 has an operating part such as an electrically operated valve, preferably, the microphone elements 140 are preferably disposed away from the part such as an electrically operated valve (for example, when the part such as an electrically operated valve is placed on the rear side of the main body, the microphone elements 140 are arranged on the front side of the main body).

Accordingly, the positions of the microphone elements 140 are determined, also taking into account at least some of sound generation sources such as the voice output unit, the drive unit, and the part such as an electrically operated valve, thus allowing the microphone elements 140 to acquire clearer voice.

### <Additional Remarks>

While embodiments have been described, it will be understood that various changes in the form or in the details may be made without departing from the spirit and scope of the claims.

### INDUSTRIAL APPLICABILITY

The air conditioner according to the first aspect through the seventeenth aspect is suitable for use as an air conditioner that can be operated via voice.

### REFERENCE SIGNS LIST

10 air conditioner
12, 12a, 12b, 12c, 12d, 12e, 12f indoor unit
16a transmission unit
16b reception unit
18a control board
20 analysis server (analysis apparatus)
30 air conditioner server (command generation apparatus)
80 network
100, 200, 300, 400, 500, 600, 700 main body
120, 220, 320, 420, 520, 620, 720 blow-out port
130, 230, 330, 430, 530, 630, 730 suction port
140 microphone element (detection unit)
150 fan
160 fan motor
170 voice processing chip (voice recognition unit, voice recognition chip)
190 voice-capture-direction adjustment mechanism
194 automatic adjustment unit
A1, A2, A3, A4, A5, A6, A7 ventilation space
C command
C0 predetermined command
D1 first direction
D2 second direction
F1, F2, F3, F4, F5, F6, F7 blow-out port forming surface (first surface)
F1a, F1b, F1c, F2a, F2b, F5a, F5b, F5c, F6a, F6b, F6c surface (second surface)
J information
M center (center of main body of floor-mounted indoor unit)
P1 (P1a1, P1a2, P1b1, P1b2, P1c, P1d1, P1d2, P1e, P1f1, P1f2) voice capturing portion
P2 (P2a1, P2a2, P2a3, P2a4, P2b, P2c, P2d, P2e) voice capturing portion
P3 (P3a, P3b, P3c) voice capturing portion
P4 (P4a, P4b, P4c, P4d) voice capturing portion
P5 (P5a, P5b, P5c, P5d, P5e) voice capturing portion
P6 (P6a, P6b, P6c) voice capturing portion
P7 (P7a, P7b) voice capturing portion
S signal

1. An air conditioner comprising:
an indoor unit including a main body having formed therein a blow-out port through which air-conditioned air is blown out toward a space to be air-conditioned, and a microphone element that accepts a voice instruction captured from a voice capturing portion connected to a wall of the main body that faces the space to be air-conditioned and arranged at a position that deviates from a ventilation space through which the air blown out from the blow-out port flows;
a transmitter that transmits a signal that is based on the voice instruction accepted by the microphone element, the signal being transmitted externally of the air conditioner; and
a receiver that receives a command corresponding to the signal transmitted from the transmitter, the command being received from externally of the air conditioner,
the blow-out port being formed so as to extend with a longitudinal direction thereof corresponding to a second direction,
the indoor unit further including a fan and an inverter fan motor that drives the fan, the fan being accommodated in the main body and a rotational axis of the fan extending in the second direction, and the inverter fan motor being disposed on one side of an inside of the main body in the second direction and being disposed on one side of the fan in the second direction, and
the voice capturing portion being disposed on an opposite side of the main body as the side on which the inverter fan motor is disposed in the second direction.

2. The air conditioner according to claim 1, wherein
the blow-out port, through which air is blown out in a first direction in a bottom view, is formed in a lower surface of the main body, and
the voice capturing portion is disposed in the lower surface of the main body at a location other than the downstream side of the blow-out port in the first direction in the bottom view.

3. The air conditioner according to claim 1, wherein
the blow-out port is formed in a first surface of the main body, and
the voice capturing portion is disposed in a second surface of the main body that intersects the first surface.

4. The air conditioner according to claim 1, wherein
the voice capturing portion is disposed on the extension of the blow-out port in the second direction.

5. The air conditioner according to claim 1, wherein
the main body further has formed therein a suction port through which air is sucked from the space to be air-conditioned, and
the voice capturing portion is disposed on the main body between the blow-out port and the suction port.

6. The air conditioner according to claim 1, wherein
the indoor unit is a wall-mounted type, and
the voice capturing portion is disposed above the blow-out port.

7. The air conditioner according to claim 1, wherein
the indoor unit is a wall-mounted type,
the indoor unit has two or more combinations, each including the voice capturing portion and the microphone element, and
the voice capturing portions are disposed at least at both ends of the main body in the second direction.

8. The air conditioner according to claim 1, wherein
the indoor unit further has a voice-capture-direction adjustment mechanism capable of changing a direction in which a voice is captured by the voice capturing portion.

9. The air conditioner according to claim 8, wherein
the indoor unit further has a detection unit configured to detect a position of a person in the space to be air-conditioned, and
the voice-capture-direction adjustment mechanism has an automatic adjustment unit configured to automatically change a direction in which the voice is captured by the voice capturing portion in accordance with a detection result of the detection unit.

10. An air conditioner comprising:
an indoor unit including a main body having formed therein a blow-out port through which air-conditioned air is blown out toward a space to be air-conditioned, and a microphone element that accepts a voice instruction captured from a voice capturing portion connected to a wall of the main body that faces the space to be air-conditioned and arranged at a position that deviates from a ventilation space through which the air blown out from the blow-out port flows;
a transmitter that transmits a signal that is based on the voice instruction accepted by the microphone element, the signal being transmitted externally of the air conditioner; and
a receiver that receives a command corresponding to the signal transmitted from the transmitter, the command being received from externally of the air conditioner,
the blow-out port being formed so as to extend with its longitudinal direction corresponding to a second direction,
the indoor unit further including a fan and electric components including a fan motor that drives the fan, the fan being accommodated in the main body and a rotational axis of the fan extending in the second direction, and the electric components being arranged on one side of an inside of the main body in the second direction and being disposed on one side of the fan in the second direction, and
the voice capturing portion being disposed on a same side of the main body as the side on which the fan motor is disposed in the second direction.

11. An air conditioner comprising:
an indoor unit including a main body having formed therein a blow-out port through which air-conditioned air is blown out toward a space to be air-conditioned, and a microphone element that accepts a voice instruction captured from a voice capturing portion connected to a wall of the main body that faces the space to be air-conditioned and arranged at a position that deviates from a ventilation space through which the air blown out from the blow-out port flows;
a transmitter that transmits a signal that is based on the voice instruction accepted by the microphone element, the signal being transmitted externally of the air conditioner; and
a receiver that receives a command corresponding to the signal transmitted from the transmitter, the command being received from externally of the air conditioner from externally of the air conditioner,
the indoor unit further including a fan and a motor that drives the fan, the fan being accommodated in the main body below a center of the main body,
the indoor unit being a floor-mountable type, and
the voice capturing portion being disposed above a center of the main body in a height direction and above the fan motor.
